(19) United States
(12) Patent Application Publication
(10) Pub. No.: US 2026/0186487 A1
(43) Pub. Date: Jul. 2, 2026

(54) INFORMATION PROCESSING METHOD, TERMINAL DEVICE, AND RECORDING MEDIUM

(71) Applicant: Panasonic Intellectual Property Management Co., Ltd., Osaka (JP)

(72) Inventors: Yuki MATSUMURA, Kanagawa (JP); Shunsuke KUHARA, Osaka (JP); Masashi OTANI, Osaka (JP); Toshiya ARAI, Osaka (JP); Tatsuya KOYAMA, Kyoto (JP)

(21) Appl. No.: 19/548,035

(22) Filed: Feb. 24, 2026

Related U.S. Application Data
(63) Continuation of application No. PCT/JP2024/030246, filed on Aug. 26, 2024.

(30) Foreign Application Priority Data
Sep. 7, 2023 (JP) 2023-145002

(51) Int. Cl. G05D 1/227; B60W 60/00

(52) U.S. Cl. CPC G05D 1/2279; B60W 60/001; B60W 2556/45

(57) ABSTRACT

An information processing method is an information processing method executed by a computer, the information processing method including: acquiring position information that indicates a current position of a mobile body and route information that indicates a travel route of the mobile body; acquiring road information; predicting at least one of a remote control intervention point or a remote control intervention timing at which an operator capable of remotely controlling the mobile body starts remote control of the mobile body, based on the position information, the route information, and the road information; determining a prediction confidence level for the at least one of the remote control intervention point or the remote control intervention timing predicted; and determining, based on the prediction confidence level determined, a display format for displaying status information that indicates a status of the mobile body to be displayed to the operator before starting the remote control.

### CROSS REFERENCE TO RELATED APPLICATIONS

This is a continuation application of PCT International Application No. PCT/JP2024/030246 filed on Aug. 26, 2024, designating the United States of America, which is based on and claims priority of Japanese Patent Application No. 2023-145002 filed on Sep. 7, 2023. The entire disclosures of the above-identified applications, including the specifications, drawings and claims are incorporated herein by reference in their entirety.

### FIELD

The present disclosure relates to an information processing method, a terminal device, and a recording medium.

### BACKGROUND

Patent Literature (PTL) 1 discloses a technique for predicting, for a vehicle that can be controlled to drive in an autonomous driving mode and a remote driving mode, a remote driving section on a driving route based on autonomous driving route information, the remote driving section being where the vehicle is required to be controlled to drive in the remote driving mode. With this technique, the driving mode can be smoothly switched from the autonomous driving mode to the remote driving mode.

### CITATION LIST

### Patent Literature

PTL 1: Japanese Unexamined Patent Application Publication No. 2021-22319

### SUMMARY

### Technical Problem

However, the technique disclosed in PTL 1 does not give consideration to the possibility of misprediction of the remote driving section. Accordingly, in the case where, for example, vehicle status information that indicates a status of the vehicle is displayed for an operator who remotely controls the vehicle immediately before the vehicle enters the remote driving section, it may cause unnecessary burden on the operator.

To address this, the present disclosure provides an information processing method, a terminal device, and a recording medium, with which it is possible to reduce unnecessary burden on an operator who is capable of remotely controlling a mobile body.

### Solution to Problem

An information processing method according to one aspect of the present disclosure is an information processing method executed by a computer, the information processing method including: acquiring position information that indicates a current position of a mobile body and route information that indicates a travel route of the mobile body; acquiring road information; predicting at least one of a remote control intervention point or a remote control intervention timing at which an operator who is capable of remotely controlling the mobile body starts remote control of the mobile body, based on the position information, the route information, and the road information; determining a prediction confidence level for the remote control intervention point or the remote control intervention timing predicted; and determining, based on the prediction confidence level determined, a display format for displaying status information that indicates a status of the mobile body to be displayed to the operator before the operator starts the remote control.

A terminal device according to one aspect of the present disclosure includes: an acquirer that acquires information that indicates a display format for displaying the status information of the mobile body determined using the above-described information processing method; and a controller that causes a display device to display the status information in the display format acquired, the display device being assigned to an operator who is in charge of remotely controlling the mobile body.

A recording medium according to one aspect of the present disclosure is a non-transitory computer-readable recording medium having recorded thereon a program for causing a computer to execute the above-described information processing method.

### Advantageous Effects

According to the aspects of the present disclosure, it is possible to implement an information processing method and the like, with which it is possible to reduce unnecessary burden on the operator who is capable of remotely controlling the mobile body.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram showing an overall configuration of an information processing system according to an embodiment.

FIG. 2 is a block diagram showing a functional configuration of a server device according to the embodiment.

FIG. 3 is a block diagram showing a functional configuration of an in-vehicle device according to the embodiment.

FIG. 4 is a block diagram showing a functional configuration of an operator terminal device according to the embodiment.

FIG. 5 is a flowchart illustrating an operation of the information processing system according to the embodiment.

FIG. 6 is a diagram showing one example of state information displayed on a display device according to the embodiment.

FIG. 7 is a diagram showing another example of state information displayed on the display device according to the embodiment.

FIG. 8 is a flowchart illustrating an operation performed by an information processing system according to Variation 1 of the embodiment.

FIG. 9 is a flowchart illustrating an operation performed by an information processing system according to Variation 2 of the embodiment.

FIG. 10 is a diagram showing one example of state information displayed on the display device according to Variation 2 of the embodiment.

FIG. 11 is a flowchart illustrating one example of an operation of selecting vehicles to be displayed on a split display screen according to Variation 2 of the embodiment.

FIG. 12 is a flowchart illustrating another example of an operation of selecting vehicles to be displayed on a split display screen according to Variation 2 of the embodiment.

FIG. 13 is a diagram illustrating a display screen switch timing according to Variation 3 of the embodiment.

FIG. 14A is a diagram showing one example of state information displayed on the display device according to Variation 4 of the embodiment.

FIG. 14B is a diagram showing one example of state information in which a display of a remote control intervention timing has been removed from the state information shown in FIG. 14A, with one or a pre-set number of remote control intervention timings being left.

FIG. 15 is a diagram showing a first example of state information displayed on the display device according to Variation 5 of the embodiment.

FIG. 16 is a diagram showing a second example of state information displayed on the display device according to Variation 5 of the embodiment.

FIG. 17 is a diagram showing a third example of state information displayed on the display device according to Variation 5 of the embodiment.

### DESCRIPTION OF EMBODIMENT

### Circumstances Leading to the Present Disclosure

Prior to describing an embodiment and the like according to the present disclosure, circumstances leading to the present disclosure will be described.

A technique has been studied to, in a scene where a remote control intervention is required to be performed on a vehicle, present a vehicle status of the vehicle on a screen (for example, an individual management screen, which will be described later) in advance for an operator. With this technique, the operator can recognize the vehicle status in advance, and thus the operator can rapidly start the remote control intervention at a timing at which the remote control intervention is required.

As used herein, the term “remote control intervention” refers to remotely controlling driving of a vehicle that is being driven in an autonomous driving mode by an operator who is distant from the vehicle. Also, the term “individual management screen” refers to a screen for the operator to recognize the vehicle status (for example, the state of the surroundings of the vehicle) based on, for example, an image, a sound, and the like obtained through an in-vehicle camera, a microphone, and the like, and the screen has a high information detail level. In other words, the individual management screen is a screen that imposes more burden and requires more time for the operator to recognize the vehicle status.

The term “information detail level” refers to, rather than the data size of information, the complexity of information for the operator to recognize. The operator can recognize more detailed vehicle status as the complexity of information increases. However, it requires significant burden and time for the operator to recognize. For example, when a comparison is made between the case where the operator views a vehicle displayed on a map screen and the case the case where the operator views a camera image captured by an in-vehicle camera, even if the data size is the same, the operator can recognize more complex information by viewing the camera image, and thus it can be said that the camera image has a higher information detail level.

In this case, a prediction is made in advance as to whether it is necessary to perform a remote control intervention on the vehicle. If it is predicted that it is necessary to perform a remote control intervention on the vehicle, the vehicle status of the vehicle is presented on the screen. However, a prediction mistake may be made when predicting whether it is necessary to perform a remote control intervention on the vehicle. The prediction mistake means that the prediction made is wrong. For example, the prediction mistake means that, despite that fact that it is actually unnecessary to perform a remote control intervention on the vehicle, it is mistakenly predicted that it is necessary to perform a remote control intervention, or in other words, it is mistakenly detected that it is necessary to perform a remote control intervention. The expression “it is necessary to perform a remote control intervention” means that remote control performed by the operator is necessary.

When the vehicle status of the vehicle for which it has been mistakenly detected that it is necessary to perform a remote control intervention on the vehicle is presented on the screen, the operator has to check, on the individual management screen, the vehicle status of the vehicle that the operator does not actually need to check, which imposes unnecessary burden on the operator. In addition, it is not possible to determine whether the detection is wrong until the vehicle actually arrives at a predicted point for the remote control intervention, and it is therefore difficult to determine in advance whether the detection is wrong. The term “burden” used here refers to burden imposed on the operator to remotely monitor the vehicle before the remote control intervention is made.

PTL 1 does not give consideration to the occurrence of a wrong detection, and thus it may cause unnecessary burden on the operator.

To address this, the inventors of the present application conducted in-depth studies on an information processing method and the like, with which it is possible to reduce unnecessary burden that may be imposed on an operator who is capable of remotely controlling a mobile body by a wrong detection, and they invented the following information processing method and the like described below.

An information processing method according to a first aspect of the present disclosure is an information processing method executed by a computer, the information processing method including: acquiring position information that indicates a current position of a mobile body and route information that indicates a travel route of the mobile body; acquiring road information; predicting at least one of a remote control intervention point or a remote control intervention timing at which an operator who is capable of remotely controlling the mobile body starts remote control of the mobile body, based on the position information, the route information, and the road information; determining a prediction confidence level for the remote control intervention point or the remote control intervention timing predicted; and determining, based on the prediction confidence level determined, a display format for displaying status information that indicates a status of the mobile body to be displayed to the operator before the operator starts the remote control.

With this configuration, the status information can be displayed in the display format according to the prediction confidence level for the remote control. For example, in the case where the prediction confidence level is low, a display format that reduces the burden on the operator is determined, and it is therefore possible to reduce unnecessary burden on the operator if the prediction is wrong. Accordingly, with the information processing method, it is possible to reduce unnecessary burden on the operator who is capable of remotely controlling the mobile body.

Also, for example, an information processing method according to a second aspect is the information processing method according to the first aspect, wherein the prediction confidence level may be determined based on a prediction accuracy of the at least one of the remote control intervention point or the remote control intervention timing predicted.

With this configuration, by using the prediction confidence level that corresponds to the prediction accuracy, it is possible to reduce unnecessary burden on the operator who is capable of remotely controlling the mobile body.

Also, for example, an information processing method according to a third aspect is the information processing method according to the second aspect, wherein the prediction confidence level may be determined based on actual performance information that includes: (i) at least one of a remote control intervention point or a remote control intervention timing predicted in a past for a reason that is same as a reason for which the remote control on the mobile body has been predicted to be necessary; (ii) and an actual performance of the remote control performed at the at least one of the remote control intervention point or the remote control intervention timing predicted in the past..

With this configuration, by using the prediction confidence level that corresponds to the actual performance information that is based on the same reason as the reason for which the remote control on the mobile body has been predicted to be necessary, it is possible to reduce unnecessary burden on the operator who is capable of remotely controlling the mobile body.

Also, for example, an information processing method according to a fourth aspect is the information processing method according to the third aspect, wherein the actual performance information may include information regarding a correct prediction accuracy rate of the remote control intervention point or the remote control intervention timing predicted in the past, and the prediction confidence level may be determined based on the correct prediction accuracy rate.

With this configuration, by using the prediction confidence level that corresponds to the correct prediction accuracy rate, it is possible to reduce unnecessary burden on the operator who is capable of remotely controlling the mobile body.

Also, for example, an information processing method according to a fifth aspect is the information processing method according to the fourth aspect, wherein a plurality of mobile bodies including the mobile body may be present, and the information processing method may further include: grouping the plurality of mobile bodies into one or more groups based on at least one of a mobile body type, environment information regarding a mobile body travel environment, or time information regarding a mobile body travel time; and calculating, for each of the plurality of mobile bodies, the correct prediction accuracy rate for calculating the prediction confidence level of the mobile body, based on actual performance information of one or more mobile bodies included in the one or more groups to which the mobile body belongs.

With this configuration, the correct prediction accuracy rate can be calculated based on the actual performance information of one or more mobile bodies included in the one or more groups to which the mobile body belongs. Accordingly, the correct prediction accuracy rate suitable for the mobile body can be calculated.

Also, for example, an information processing method according to a sixth aspect is the information processing method according to the first aspect, wherein the prediction confidence level may be determined based on a reason occurrence probability of a reason for which the remote control on the mobile body has been predicted to be necessary.

With this configuration, by using the prediction confidence level that corresponds to the reason occurrence probability, it is possible to reduce unnecessary burden on the operator who is capable of remotely controlling the mobile body.

Also, for example, an information processing method according to a seventh aspect is the information processing method according to the sixth aspect, wherein a plurality of mobile bodies including the mobile body may be present, and the information processing method may further include: grouping the plurality of mobile bodies into one or more groups based on at least one of a mobile body type, environment information regarding a mobile body travel environment, or time information regarding a mobile body travel time; and calculating, for each of the plurality of mobile bodies, the correct prediction accuracy rate for calculating the prediction confidence level of the mobile body, based on actual performance information of one or more mobile bodies included in the one or more groups to which the mobile body belongs, and the actual performance information may include information regarding the reason occurrence probability.

With this configuration, the occurrence probability can be calculated based on the actual performance information of one or more mobile bodies included in the one or more groups to which the mobile body belongs. Accordingly, the occurrence probability suitable for the mobile body can be calculated.

Also, for example, an information processing method according to an eighth aspect is the information processing method according to any one of the first to seventh aspects, wherein the information processing method may further include: determining whether the prediction confidence level is greater than a threshold value, and when the prediction confidence level is determined to be greater than the threshold value, determining the display format to a format that has an information detail level higher than an information detail level when the prediction confidence level is determined to be less than or equal to the threshold value.

With this configuration, when the prediction confidence level is determined to be less than or equal to the threshold value, the display format with a low information detail level is determined. Accordingly, even when the prediction that the prediction confidence level is less than or equal to the threshold value is wrong, it is possible to further reduce unnecessary burden on the operator who is capable of remotely controlling the mobile body.

Also, for example, an information processing method according to a ninth aspect is the information processing method according to the eighth aspect, wherein when the prediction confidence level is determined to be greater than the threshold value, an image of surroundings of the mobile body captured by and acquired from the mobile body may be displayed, and when the prediction confidence level is determined to be less than or equal to the threshold value, information regarding the mobile body may be displayed on map information.

With this configuration, when the prediction confidence level is greater than the threshold value, it is possible to allow the operator to check the vehicle status in detail using the image, and when the prediction confidence level is less than or equal to the threshold value, it is possible to allow the operator to check the vehicle status with less burden using the map information.

Also, for example, an information processing method according to a tenth aspect is the information processing method according to the ninth aspect, wherein the image may be displayed for a fixed period of time when the prediction confidence level is determined to be greater than the threshold value.

With this configuration, it is possible to reduce the burden on the operator caused by the display being switched frequently.

Also, for example, an information processing method according to an eleventh aspect is the information processing method according to the ninth aspect, wherein whether to display the image may be determined based on history information regarding a history of determinations as to whether the prediction confidence level is greater than the threshold value.

With this configuration, it is possible to reduce the burden on the operator caused by the display being switched frequently.

Also, for example, an information processing method according to a twelfth aspect is the information processing method according to any one of the eighth to eleventh aspects, wherein the prediction confidence level may be determined for each of the plurality of mobile bodies, and when the plurality of mobile bodies include two or more mobile bodies whose prediction confidence level is greater than the threshold value, the display format for displaying the status information that indicates a status of one of the two or more mobile bodies that is identified based on an influence when the start of the remote control is delayed may be determined.

With this configuration, when the plurality of mobile bodies include two or more mobile bodies whose prediction confidence level is greater than the threshold value, it is possible to determine the display format for only one mobile body based on the influence when the start of the remote control is delayed.

Also, for example, an information processing method according to a thirteenth aspect is the information processing method according to any one of the first to twelfth aspects, wherein the prediction confidence level may be determined for each of the plurality of mobile bodies, and, in a predetermined number of split display regions into which a display screen on a display device is divided, based on the prediction confidence level of each of the plurality of mobile bodies, the status information of a predetermined number of mobile bodies corresponding to the predetermined number of split display regions may be displayed.

With this configuration, in the case where there are a plurality of mobile bodies whose prediction confidence level is greater than the threshold value, it is possible to display, to the operator, the status information of a predetermined number of mobile bodies.

Also, for example, an information processing method according to a fourteenth aspect is the information processing method according to the thirteenth aspect, wherein one of the predetermined number of split display regions in which the status information of a new mobile body is displayed may be displayed in a highlighted manner.

With this configuration, the operator can easily recognize the status information of the newly added mobile body on the split display screen. Accordingly, the burden on the operator when the split display screen is used can be reduced.

Also, for example, an information processing method according to a fifteenth aspect is the information processing method according to the thirteenth or fourteenth aspect, wherein the predetermined number of split display regions may be determined based on content of the remote control that the operator is to perform.

With this configuration, a predetermined number of mobile bodies is determined according to the content of the remote control. Accordingly, it is possible to suppress, for example, an increase in the burden on the operator caused by an excessive number of mobile bodies being set as the predetermined number of mobile bodies.

Also, for example, an information processing method according to a sixteenth aspect is the information processing method according to any one of the first to fourteenth aspect, wherein the prediction confidence level may be determined for each of the plurality of mobile bodies, and when the prediction confidence level of the mobile body is determined to be less than or equal to a threshold value, information for changing the threshold value may be displayed to the operator.

With this configuration, the threshold value can be changed. For example, by setting the threshold value to a high value, the percentage of images with a high information detail level being displayed is reduced. Accordingly, it is possible to the burden on the operator to check the status information.

Also, for example, an information processing method according to a seventeenth aspect is the information processing method according to any one of the first to fifteenth aspect, wherein the road information may include section information that indicates at least one of a section where autonomous driving is prohibited or a section where autonomous driving is not permitted to be continued, and the at least one of the remote control intervention point or the remote control intervention timing may be predicted based on the section information.

With this configuration, it is possible to predict the remote control intervention point or the remote control intervention timing using the section information. Accordingly, it is possible to make a more accurate prediction.

Also, a terminal device according to an eighteenth aspect of the present disclosure includes: an acquirer that acquires information that indicates a display format for displaying the status information of the mobile body determined using the information processing method according to any one of the first to seventeenth aspects; and a controller that causes a display device to display the status information in the display format acquired, the display device being assigned to the operator who is in charge of remotely controlling the mobile body.

With this configuration, the terminal device can cause the status information to be displayed to the operator in the display format that corresponds to the prediction confidence level for the remote control. For example, in the case where the prediction confidence level is low, the status information can be displayed in a display format that reduces the burden on the operator. Accordingly, with the terminal device, it is possible to reduce unnecessary burden on the operator who is capable of remotely controlling the mobile body.

Also, a recording medium according to a nineteenth aspect of the present disclosure is a non-transitory computer-readable recording medium having recorded thereon a program for causing a computer to execute the information processing method according to any one of the first to seventeenth aspects.

With this configuration, the same advantageous effects as those of the above-described information processing method can be obtained.

These general or specific aspects may be implemented using a system, a method, an integrated circuit, a computer program, or a computer-readable non-transitory recording medium such as a compact disc read-only memory (CD-ROM), or any combination thereof. The program may be stored in advance in the recording medium, or may be supplied to the recording medium via a wide area communication network including the Internet or the like.

Hereinafter, an embodiment will be described specifically with reference to the drawings.

The embodiment described below shows a generic or specific example of the present disclosure. The numerical values, shapes, structural elements, the arrangement and connection of the structural elements, steps, the order of the steps, and the like shown in the following embodiment are merely examples, and therefore are not intended to limit the scope of the present disclosure. Also, among the structural elements described in the following embodiment, structural elements not recited in any one of the independent claims are described as arbitrary structural elements.

Also, the diagrams are schematic representations, and thus are not necessarily true to scale. Accordingly, for example, the dimensions and the like in the diagrams do not necessarily match. Also, in the diagrams, structural elements that are substantially the same are given the same reference numerals, and a redundant description is omitted or simplified.

Also, the numerical values and the numerical value ranges in the specification of the present application are expressions that not only have a strict meaning, but also encompass a substantially equal range, for example, a margin of about several percent (or about 10%).

### Embodiment

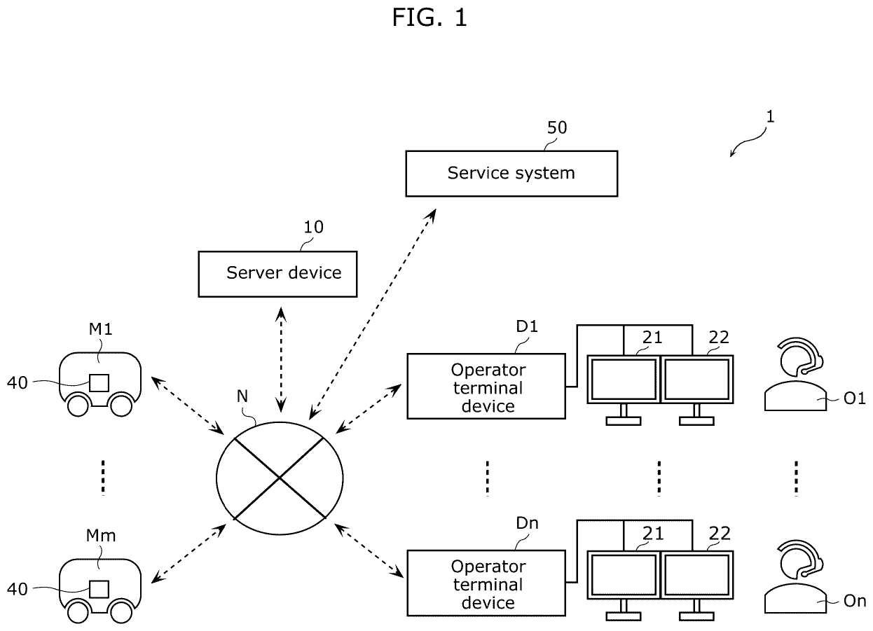

Hereinafter, an information processing method and the like according to the present embodiment will be described with reference to FIGS. 1 to 7.

### [1. Configuration of Information Processing System]

First, a configuration of an information processing system according to the present embodiment will be described with reference to FIGS. 1 to 4. FIG. 1 is a diagram showing an overall configuration of information processing system 1 according to the present embodiment.

As shown in FIG. 1, information processing system 1 is an information processing system in which a plurality operators (operators O1, . . . , and On) remotely monitor and remotely control a plurality of vehicles (vehicles M1, . . . , and Mm) that are vehicles to be operated. Information processing system 1 includes server device 10 and operator terminal devices D1, . . . , and Dn. Also, information processing system 1 may include vehicles M1, . . . , and Mm, and service system 50. As used herein, the terms “to remotely control” and “remote control” mean that operators O1 and the like perform acceleration/deceleration control and steering angle control on vehicles M1 and the like via network N as needed.

There is no particular limitation on the number of operator terminal devices D1, . . . , and Dn included in information processing system 1 and the number of vehicles M1, . . . , and Mm included in information processing system 1 as long as there is one or more operator terminal devices and there is one or more vehicles. Hereinafter, operator terminal devices D1, . . . , and Dn may also be referred to as “operator terminal devices D1 and the like”, and vehicles M1, . . . , and Mm may also be referred to as “vehicles M1 and the like. Operators O1, . . . , and On for remotely monitoring and remotely controlling vehicles M1 and the like using operator terminal devices D1 and the like are assigned to operator terminal devices D1 and the like in one-to-one correspondence. Hereinafter, operators O1, . . . , and On may also be referred to as “operators O1 and the like”. Operators O1, . . . , and On may be in charge of, for example, remotely controlling different vehicles.

Server device 10 is a processing device that executes various types of processing for remotely monitoring and remotely controlling vehicles M1 and the like. Server device 10 has a feature in that server device 10 changes a notification method for notifying operators O1 and the like of the status of vehicles M1 and the like based on a prediction accuracy when it is predicted that remote control is required to be performed on vehicles M1 and the like. Although details will be described later, the notification method refers to, for example, a display method (display format). Also, the prediction accuracy can be acquired based on the reason for the prediction that remote control is required to be performed.

The reason for the prediction that remote control is required to be performed is set in advance, and may be acquired from, for example, road information. The reason for the prediction that remote control is required to be performed may be, for example, a vehicle being involved in a traffic jam, a vehicle being in a section in which autonomous driving is not allowed, an accident occurring, an obstacle such as a fallen object being present, or the like. However, the reason is not limited thereto.

Server device 10 is installed in a location where server device 10 can be connected to network N to be capable of performing communication with network N, and there is no particular limitation on the physical position of server device 10. As one example, server device 10 may be installed within or near a space where operator terminal devices D1 and the like are provided. This configuration is advantageous in that server device 10 can perform communication with operator terminal devices D1 and the like in a short time.

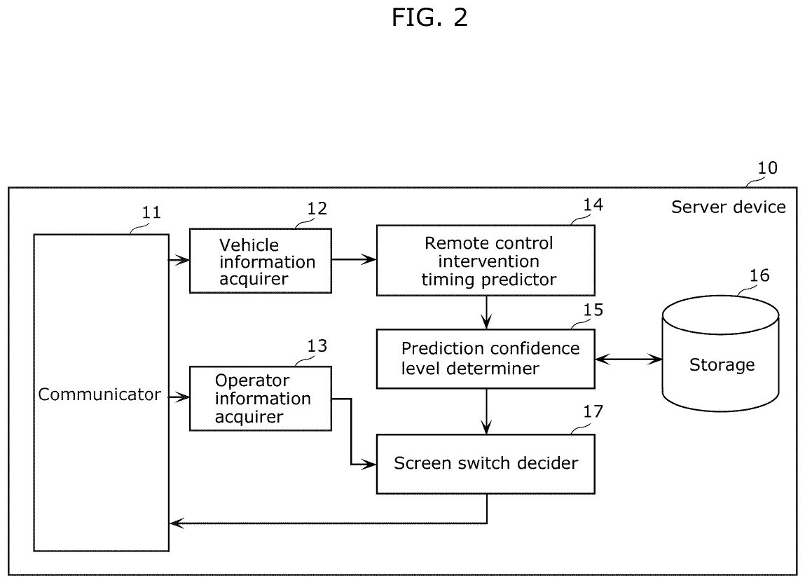

FIG. 2 is a block diagram showing a functional configuration of server device 10 according to the present embodiment.

As shown in FIG. 2, server device 10 includes communicator 11, vehicle information acquirer 12, operator information acquirer 13, remote control intervention timing predictor 14, prediction confidence level determiner 15, storage 16, and screen switch decider 17. Server device 10 is implemented using, for example, a computer.

Communicator 11 performs communication with each of vehicles M1 and the like, each of operator terminal devices D1 and the like, and service system 50 via network N. Communicator 11 is configured to include a communication circuit (a communication module).

Vehicle information acquirer 12 acquires vehicle information from each of vehicles M1 and the like via communicator 11 The vehicle information includes: sensing data of one or more sensors included in the vehicle; position information that indicates a current position of the vehicle, image data obtained by capturing images of the surroundings of the vehicle; and the like. Also, the vehicle information may include: route information that indicates a driving route for the vehicle to perform autonomous driving; sound information that indicates a sound picked up by a microphone included in the vehicle; and the like. The driving route corresponds to one example of a travel route.

Also, vehicle information acquirer 12 acquires road information from a server device or the like that manages the road information. The road information includes section information that indicates at least one of a section where autonomous driving is prohibited or a section where autonomous driving is not permitted to be continued. The road information includes: for example, traffic jam information; event information that indicates an event on the road such as a construction, an accident, a festival, or the like; section information regarding a section where vehicles M1 and the like cannot continue driving; and the like.

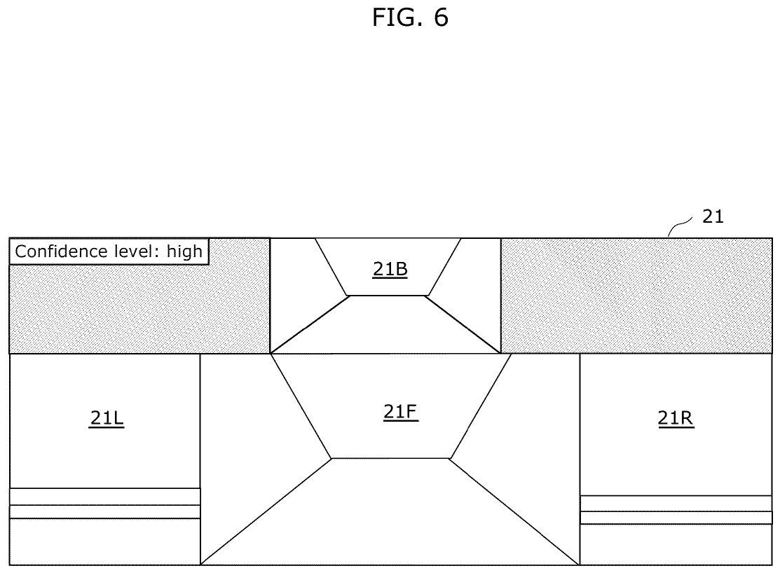

Operator information acquirer 13 acquires operator information regarding operators O1 and the like from each of operator terminal devices D1 and the like via communicator 11. The operator information includes information that indicates a status of the operator. The operator information may include at least one of screen information that is presented to operator O1, a remote control intervention skill of operator O1, or a fatigue level of operator O1. The screen information may include information that indicates at least one of a vehicle shown on an individual management screen (see, for example, FIG. 6), a remote control intervention timing, a prediction confidence level, or whether operator O1 is performing remote control.

Remote control intervention timing predictor 14 predicts a remote control intervention timing at which each of operators O1 and the like remotely controls one of vehicles M1 and the like. Remote control intervention timing predictor 14 predicts, for example, a remote control intervention timing for remotely controlling vehicle M1 based on the position information of vehicle M1, the route information of vehicle M1, and the road information. Remote control intervention timing predictor 14 may predict that there is no remote control intervention timing, or in other words, it is unnecessary to perform a remote control intervention.

Alternatively, remote control intervention timing predictor 14 may predict, instead of or together with the remote control intervention timing, a remote control intervention point at which each of operators O1 and the like starts remote control of one of vehicles M1 and the like. As used herein, the term “remote control intervention point” refers to a point at which each of operators O1 and the like starts remote control, and is also a point on the driving route of the vehicle where the vehicle has not yet been driven. The remote control intervention point may be indicated using, for example, a latitude, a longitude, and an altitude.

As described above, remote control intervention timing predictor 14 may predict, based on the position information, the route information, and the road information, at least one of a remote control intervention point or a remote control intervention timing at which each of operators O1 and the like who is capable of remotely controlling one of vehicles M1 and the like starts remote control of the corresponding vehicle. In the case where the road information includes the section information, remote control intervention timing predictor 14 may predict at least one of the remote control intervention point or the remote control intervention timing at which the operator starts the remote control based on the position information, the route information, and the section information.

Prediction confidence level determiner 15 determines, based on a reason for the prediction that remote control is required to be performed on each of vehicles M1 and the like, a confidence level (prediction confidence level) for the prediction made by remote control intervention timing predictor 14, or in other words, at least one of the remote control intervention timing or the remote control intervention point predicted. As used herein, the term “confidence level” refers to a likelihood that the remote control intervention predicted by remote control intervention timing predictor 14 is actually performed, or in other words, a prediction accuracy for the remote control intervention predicted by remote control intervention timing predictor 14.

Prediction confidence level determiner 15 may determine the confidence level based on, for example, actual performance information that indicates a remote control intervention timing predicted in the past and whether a remote control intervention was actually performed during a predetermined period of time that includes the remote control intervention timing predicted in the past. Alternatively, prediction confidence level determiner 15 may determine the confidence level based on, for example, actual performance information that indicates a remote control intervention point predicted in the past and whether a remote control intervention was actually performed in a predetermined range that includes the remote control intervention point predicted in the past.

As described above, prediction confidence level determiner 15 determines the prediction confidence level based on actual performance information that includes: at least one of a remote control intervention point or a remote control intervention timing predicted in a past for a reason that is same as a reason for which the remote control on the mobile body has been predicted to be necessary; and an actual performance of the remote control performed at the at least one of the remote control intervention point or the remote control intervention timing predicted in the past. The actual performance information is provided for each reason for which it was predicted that remote control was required to be performed on vehicles M1 and the like.

Storage 16 stores various type of information that are used in various types of processing performed by server device 10. Storage 16 stores map information, the actual performance information regarding the actual performance performed for the prediction made by remote control intervention timing predictor 14, and the like. The actual performance information may include, for example, information that indicates a correct prediction accuracy rate of the prediction made by remote control intervention timing predictor 14, or may include a reason occurrence probability (a certainty level). The occurrence probability may be a probability that the reason occurs out of a plurality of reasons, or may be a probability that the reason occurs during a predetermined period of time. Also, storage 16 may store route information of each of vehicles M1 and the like.

Storage 16 is implemented using, for example, a semiconductor memory or the like, but storage 16 is not limited thereto.

Screen switch decider 17 determines, based on the prediction confidence level determined by prediction confidence level determiner 15, a display format for displaying the status information of each of vehicles M1 and the like, which is displayed for one of operators O1 and the like before the remote control is started. For example, in the case where operator O1 is in charge of vehicle M1, screen switch decider 17 determines, based on the prediction confidence level of vehicle M1, a display format for displaying the status of vehicle M1 to operator O1.

Also, screen switch decider 17 determines whether a vehicle that is currently displayed on the individual management screen to operator O1 included in the operator information is different from a vehicle for which the next remote control intervention timing has been predicted. If the two vehicles are different, screen switch decider 17 determines whether to switch the vehicle displayed on the individual management screen. Screen switch decider 17 may determine to switch the vehicle displayed on individual management screen if it is determined that, for example, the two vehicles are different.

Also, even if it is determined that the vehicle that is currently displayed on the individual management screen to operator O1 is the same as the vehicle for which the next remote control intervention timing has been predicted, when the prediction confidence level of at least one of the remote control intervention timing or the remote control intervention point falls to a value less than or equal to a predetermined value, screen switch decider 17 may determine whether to switch the display format from the current display format to another display format. For example, if the prediction confidence level of one vehicle varies over time and falls to a value less than or equal to a predetermined value from a value greater than the predetermined value, screen switch decider 17 may determine to switch the display format of the one vehicle from the individual management screen to an overall management screen.

Also, in the case where operator O1 is already performing remote control of another vehicle, screen switch decider 17 may determine to not switch the display format, or may increase a threshold value for the prediction confidence level of at least one of the remote control intervention timing or the remote control intervention point for which it is determined whether to switch to the individual management screen. As described above, even when the prediction confidence level is greater than or equal to the threshold value, depending on the status of operator O1, screen switch decider 17 may determine to not switch to the individual management screen, or may dynamically change the threshold value. The threshold value may be determined for at least one of a point in time at which the remote control intervention was predicted, a location where the vehicle was present when the remote control intervention was predicted, details of the remote control intervention, or vehicle information. The vehicle information includes at least one of a vehicle model, a vehicle performance, or a vehicle size.

Also, screen switch decider 17 may determine priority based on a safety risk, a service effect, and the like, the priority indicating which of the vehicle that is currently displayed to operator O1 and the vehicle for which the next remote control intervention timing has been predicted should be given priority for operation. For example, screen switch decider 17 may determine the vehicle whose display format is to be switched to the individual management screen based on, in addition to the prediction confidence level, the safety risk, the service effect, and the like.

Screen switch decider 17 may give priority to remotely controlling, for example, a vehicle stuck on a heavy traffic road over a vehicle stuck on a low traffic road. With this configuration, an image of the vehicle stuck on the heavy traffic road is preferentially displayed. Accordingly, an effect of reducing the safety risk can be expected. Also, screen switch decider 17 may give priority to remotely controlling, for example, a vehicle that is heading for a user who is waiting at a destination over a vehicle that is being driven around to receive an order such as food delivery. With this configuration, an image of the vehicle that is heading for the user who is waiting at the destination such as food delivery is preferentially displayed. Accordingly, an effect of increasing the service effect can be expected.

Vehicles M1 and the like are occupied or unoccupied vehicles, and may be, for example, self-driving vehicles, or autonomous mobile robots that provide a predetermined service such as delivery. Vehicles M1 and the like are vehicles to be remotely monitored and remotely controlled by operators O1 and the like. Vehicles M1 and the like are present on a road, a parking place, a sidewalk, and the like. Vehicle M1 and the like correspond to one example of a mobile body.

Each of Vehicles M1 and the like includes: one or more cameras that capture images of the surroundings of the vehicle; and a plurality of sensors that detect an own vehicle speed, an acceleration, a jerk (a rate of change of acceleration over time), a steering angle, a fuel level, an operation status of a turn signal, an operation status of an anti-lock braking system (ABS) or an automatic emergency braking (AEB), presence or absence of an object in the surroundings, the number of objects in the surroundings, the type of object in the surroundings, the distance to the object in the surroundings, a speed difference, an acceleration difference, and the like. Each of vehicles M1 and the like transmits, to server device 10 via a communication interface and network N, image data of images captured by the one or more cameras and sensing data acquired by the plurality of sensors such as the own vehicle speed and the presence or absence of an object in the surroundings by including them into vehicle information.

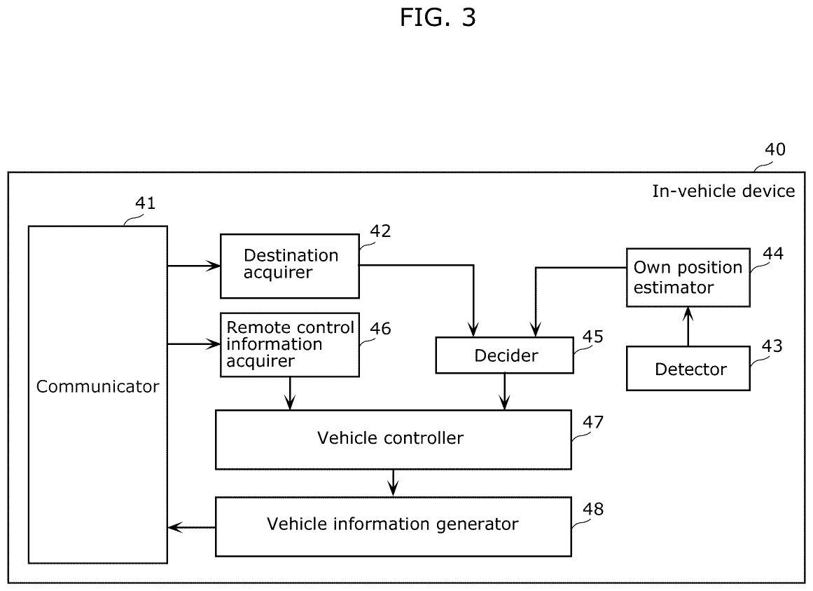

Each of vehicles M1 and the like includes in-vehicle device 40. In-vehicle device 40 will be described with reference to FIG. 3. FIG. 3 is a block diagram showing a functional configuration of in-vehicle device 40 according to the present embodiment.

As shown in FIG. 3, in-vehicle device 40 includes communicator 41, destination acquirer 42, detector 43, own position estimator 44, decider 45, remote control information acquirer 46, vehicle controller 47, and vehicle information generator 48.

Communicator 41 performs communication with server device 10 and operator terminal devices D1 and the like via network N. Communicator 41 is configured to include a communication circuit (a communication module).

Destination acquirer 42 acquires, via communicator 41, destination information that indicates a destination to which the own vehicle is driven. In the case where the own vehicle provides a predetermined service, destination acquirer 42 may acquire the destination information from service system 50. Also, in the case where there is a passenger in the own vehicle, destination acquirer 42 may acquire the destination information based on an operation input into an input device from the passenger. The input device includes, for example, a button, a touch panel, and the like, but may be configured to receive an operation using a sound/voice or a gesture.

Detector 43 is a sensor that performs detection regarding the own vehicle. Detector 43 includes a sensor that detects information for estimating the current position of the own vehicle such as, for example, a global positioning system (GPS) sensor that receives a GPS signal output from a GPS satellite. Also, detector 43 may include the plurality of sensors described above.

Own position estimator 44 estimates the current position of the own vehicle based on the result of detection performed by detector 43. Own position estimator 44 may estimate the current position of the own vehicle based on, for example, the GPS signal received by detector 43.

The current position may be estimated using any known technique other than the method that uses the GPS signal.

Decider 45 determines, based on the own position and the destination of the own vehicle, driving information for performing autonomous driving. The driving information includes a driving route, a driving schedule, and the like.

Remote control information acquirer 46 acquires remote control information from operator terminal devices D1 and the like via communicator 41.

Vehicle controller 47 controls driving of the own vehicle. In the case where the own vehicle is in the autonomous driving mode, vehicle controller 47 controls driving of the own vehicle based on the driving information determined by decider 45. In the case where the own vehicle is in the remote control driving mode, vehicle controller 47 controls driving of the own vehicle based on the remote control information acquired by remote control information acquirer 46.

Vehicle information generator 48 generates vehicle information based on the result of detection performed by detector 43. Vehicle information generator 48 may generate, for example, vehicle information that includes at least the current position of the own vehicle and image data obtained by capturing images of the surroundings of the vehicle. The generated vehicle information is transmitted to server device 10 via communicator 41.

Referring back again to FIG. 1, operator terminal devices D1 and the like are terminal devices used by operators O1 and the like, and execute processing of presenting (for example, displaying) the information acquired from server device 10 for operators O1 and the like and outputting the information (for example, the remote control information) that is based on the input from operators O1 and the like to vehicles M1 and the like. Operator terminal device D1 and the like correspond to one example of a terminal device.

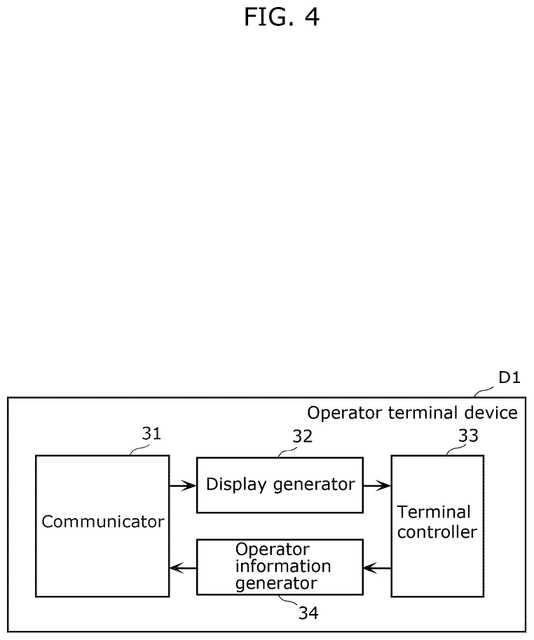

FIG. 4 is a block diagram showing a functional configuration of operator terminal device D1 according to the present embodiment. Operator terminal devices D1 and the like may have the same configuration. Hereinafter, operator terminal device D1 used by operator O1 will be described.

As shown in FIG. 4, operator terminal device D1 includes communicator 31, display generator 32, terminal controller 33, and operator information generator 34. Also, operator terminal device D1 is connected to first display device 21 and second display device 22. There is no particular limitation on the number of first display devices 21 and second display devices 22 that are connected to operator terminal device D1 as long as there is one or more first display devices 21 and second display devices 22.

First display device 21 displays, for example, the status information of one of vehicles M1 and the like for which it has been predicted that a remote control intervention is required. In the present embodiment, first display device 21 displays an image of the surroundings of the vehicle for which it has been predicted that a remote control intervention is required. It can be said that first display device 21 is also a display device for displaying an individual management screen, which will be described later. With this configuration, operator O1 can recognize, by simply viewing the screen on first display device 21, a detailed status of the vehicle for which it has been predicted that a remote control intervention is required before operator O1 starts the remote control intervention.

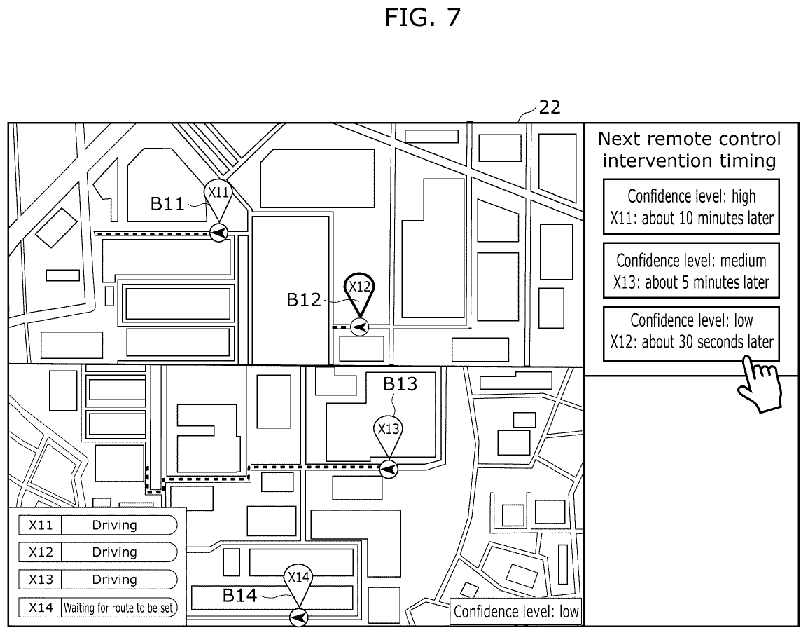

Second display device 22 displays, for example, an image that shows, in a simplified manner, the status information of each of one or more vehicles assigned to the operator out of vehicles M1 and the like. In the present embodiment, second display device 22 displays information regarding the one or more vehicles assigned to the operator on a map for the operator to check comprehensively. It can also be said that second display device 22 is also a display device for displaying an overall management screen, which will be described later (see, for example, FIG. 7). With this configuration, operator O1 can recognize the status of each of the one or more vehicles assigned to the operator by simply viewing the image displayed on second display device 22. The overall management screen is, for example, a map screen on which the vehicle position, the driving route, and the like are superimposed, and has an information detail level lower than that of the individual management screen. In other words, the overall management screen is a screen that does not require less burden and time for operator O1 to check the vehicle status, as compared with the individual management screen.

Each of first display device 21 and second display device 22 is implemented using, for example, a liquid crystal display device, an organic electroluminescent (EL) display device, or the like. However, each of first display device 21 and second display device 22 is not limited thereto.

Second display devices 22 that are connected to operator terminal devices D1 and the like may display the same image. For example, second display devices 22 that are connected to operator terminal devices D1 and the like may display an image that shows, in a simplified manner, the status of all of vehicles M1 and the like included in information processing system 1. Also, two or more of operators O1 and the like may use one second display device 22 in a shared manner.

First display device 21 may display, on the individual management screen, an image of the surroundings of the vehicle whose prediction confidence level is greater than the threshold value, or may display, on the individual management screen, an image of the surroundings of only the vehicle whose prediction confidence level is greater than the threshold value and whose remote control intervention timing is within a predetermined period of time (for example, soon) from the present time. The status information of the vehicle whose prediction confidence level is greater than the threshold value and whose remote control intervention timing takes place at a time more than the predetermined period of time from the present time may be displayed on the overall management screen on second display device 22. As described above, first display device 21 may display, on the individual management screen, an image of the surroundings of only the vehicle whose prediction confidence level is greater than the threshold value and that satisfies another predetermined condition. As used herein, the term “soon” refers to several minutes or tens of minutes.

First display device 21 and second display device 22 may be implemented using different display devices (different displays) or one display device (one display). In the case where first display device 21 and second display device 22 are implemented using one display device, first display device 21 and second display device 22 may be implemented by dividing the same display into a first display portion and a second display portion. In this case, the first display portion and the second display portion are implemented using different display regions on one display.

Communicator 31 performs communication with server device 10 and vehicles M1 and the like via network N. Communicator 31 acquires, for example, information that indicates a display format for displaying the status information of vehicles M1 and the like determined by server device 10. Communicator 31 is configured to include a communication circuit (a communication module). Communicator 31 corresponds to one example of an acquirer.

Display generator 32 generates images to be displayed on first display device 21 and second display device 22 based on the display format determined by server device 10.

Terminal controller 33 controls the structural elements of operator terminal device D1. Also, terminal controller 33 controls the display format for displaying the status information of vehicles M1 and the like to be displayed on first display device 21 and second display device 22. In the case where operator O1 is in charge of vehicle M1, terminal controller 33 causes the status information of vehicle M1 to be displayed on the display devices that are connected to operator terminal device D1 in the display format acquired via communicator 31. Terminal controller 33 outputs image data generated by display generator 32 to first display device 21 and second display device 22.

Also, terminal controller 33 is connected to a user interface (not shown) that receives an input from operator O1 when remotely controlling vehicle M1, and may acquire the input from operator O1 via the user interface. The user interface is a device that receives an input from operator O1 via a button, a stick, a touch panel, or the like, but may be, for example, a device that receives an input using a sound/voice, a gesture, or the like. Also, the user interface may be a mobile body-specific device such as, for example, a steering wheel, a brake, or an accelerator. Terminal controller 33 corresponds to one example of a controller.

Operator information generator 34 generates operator information based on at least one of screen information that is presented by first display device 21 and second display device 22 to operator O1 or an input from operator O1 on the screen via the user interface, and transmits the operator information to server device 10 and the like via communicator 31. The operator information includes remote control information, operator status information, and the like.

Operator terminal device D1 may be configured to include first display device 21 and second display device 22.

Service system 50 is an information processing system that executes processing regarding a predetermined service executed by vehicles M1 and the like. Service system 50 may be configured to include, for example, a server device that is managed by a provider or the like that provides the service. Service system 50 may transmit, for example, destination information to a vehicle that executes the service.

### [2. Operation of Information Processing System]

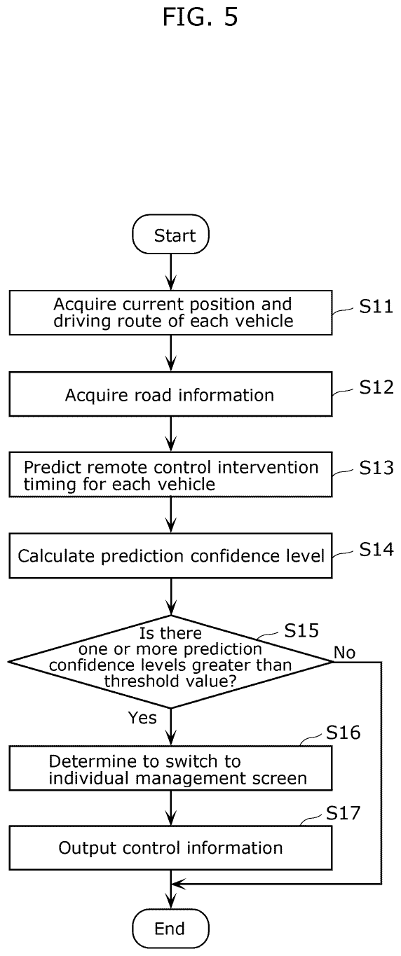

Next, an operation of information processing system 1 configured as described above will be described with reference to FIGS. 5 to 7. FIG. 5 is a flowchart illustrating an operation (an information processing method) of information processing system 1 according to the present embodiment. FIG. 5 shows an operation executed by server device 10. In FIG. 5, an example will be described in which, out of the remote control intervention point and the remote control intervention timing, remote control intervention timing predictor 14 predicts the remote control intervention timing.

As shown in FIG. 5, vehicle information acquirer 12 of server device 10 acquires, from each of vehicles M1 and the like via communicator 11, vehicle information that includes the current position and the driving route of the vehicle (S11). Vehicle information acquirer 12 acquires the vehicle information from each of vehicles M1 and the like, for example, on a regular basis.

Next, vehicle information acquirer 12 acquires road information regarding the current road from the server device or the like that manages the road information (S12). Vehicle information acquirer 12 may acquire, for example, road information regarding a region that includes the driving route of each of vehicles M1 and the like. Vehicle information acquirer 12 may acquire the road information, for example, on a regular basis or at a timing at which vehicle information acquirer 12 acquires the vehicle information.

The next remote control intervention timing predictor 14 predicts a remote control intervention timing for each vehicle (each of vehicles M1 and the like) based on position information that indicates the current position of the vehicle (each of vehicles M1 and the like), route information that indicates a travel route of the vehicle (each of vehicles M1 and the like), and the road information (S13). Remote control intervention timing predictor 14 determines whether remote control is required to be performed on vehicle M1 based on the position information of vehicle M1, the route information of vehicle M1, and the road information, and predicts a remote control intervention timing for remotely controlling vehicle M1 for which it has been determined that remote control is required to be performed. Remote control intervention timing predictor 14 predicts, for example, based on the current position of vehicle M1 and the driving route of vehicle M1, a clock time at which vehicle M1 enters a section indicated by section information that is included in the road information. The remote control intervention timing is a future clock time after the clock time at which the prediction is made by remote control intervention timing predictor 14.

The remote control intervention timing is, for example, a clock time at which it has been predicted that vehicle M1 first passes through a position in the set section. The remote control intervention timing may be, for example, a clock time at which vehicle M1 first enters the set section. The route information of vehicle M1 is information regarding the travel route of vehicle M1. Remote control intervention timing predictor 14 may predict the clock time at which vehicle M1 passes through a position in the set section based on the position in the set section on the travel route that has been predicted that vehicle M1 first passes through after the current position, the distance between the current position and the position in the set section, and speed information of vehicle M1.

As used herein, the term “section” encompasses, for example, at least one of the following sections included in the road information including: a section where autonomous driving is prohibited, a section where autonomous driving is not permitted to be continued, a section where a traffic jam is taking place, a section in which an accident has occurred, a section in which an obstacle such as a fallen object is present, or a section where an event such as a festival is taking place on the road. The remote control intervention point refers to a position in any one of the sections described above and the like.

The plurality of sections may be set by a route group being divided at predetermined points such as intersections. One route from one intersection to the next intersection may be divided into two sections according to the traffic flow direction. Also, assuming that a remote control intervention may be performed at an intersection, the intersection may be divided into a plurality of sections according to the entry route. As described above, a specific area such as an intersection may be divided into a plurality of sections. In the case where a section has a length greater than or equal to a certain distance, a unit distance may be set in advance, and the section may be divided into separate sections according to the unit distance. For example, each of the plurality of sections may be a section that has a length less than or equal to the pre-set unit distance.

Next, prediction confidence level determiner 15 determines a confidence level by calculating a prediction confidence level of the remote control intervention timing predicted by remote control intervention timing predictor 14 for each of vehicles M1 and the like (S14). Prediction confidence level determiner 15 determines the prediction confidence level based on, for example, actual performance information. Prediction confidence level determiner 15 may calculate a correct prediction accuracy rate of the prediction the prediction made by remote control intervention timing predictor 14 for each of reasons stored in storage 16 for which it was predicted that remote control is required to be performed on vehicles M1 and the like, and calculate a value based on the correct prediction accuracy rate as the prediction confidence level. Prediction confidence level determiner 15 may calculate the prediction confidence level such that the higher the correct prediction accuracy rate of the prediction, the higher the prediction confidence level.

The correct prediction accuracy rate may be determined by, for each reason, classifying the prediction as being “correct” when the remote control intervention was actually performed at the remote control intervention timing (or during a predetermined period of time including the remote control intervention timing) predicted by remote control intervention timing predictor 14 in the past, or “incorrect” when the remote control intervention was not performed at the remote control intervention timing (or during the predetermined period of time including the remote control intervention timing), and calculating the ratio between correct and incorrect classifications. For example, in the case where, for one reason, remote control intervention timing predictor 14 predicted the remote control intervention timing ten times in the past, with eight out of ten being classified as “correct” and two out of ten being classified as “incorrect”, prediction confidence level determiner 15 may determine the correct prediction accuracy rate for the reason to be 80%. Information regarding whether the predicted remote control intervention timing is correct or incorrect corresponds to one example of actual performance information.

Also, the correct prediction accuracy rate may be determined by, for each reason, classifying the prediction as being “correct” when the remote control intervention was actually performed at the remote control intervention point (or in a predetermined area including the remote control intervention point) predicted by remote control intervention timing predictor 14 in the past, or “incorrect” when the remote control intervention was not performed at the remote control intervention point (or in the predetermined area including the remote control intervention point), and calculating the ratio between correct and incorrect classifications. For example, in the case where, for one reason, remote control intervention timing predictor 14 predicted the remote control intervention point ten times in the past, with seven out of ten being classified as “correct” and three out of ten being classified as “incorrect”, prediction confidence level determiner 15 may determine the correct prediction accuracy rate for the reason to be 70%.

Prediction confidence level determiner 15 may group the plurality of vehicles M1 and the like into groups based on at least one of a type of vehicle M1, environment information regarding a travel environment of vehicle M1, or time information regarding a travel time of vehicle M1, and calculate the correct prediction accuracy rate for calculating the prediction confidence level of vehicle M1 based on the actual performance information of one or more vehicles included in one of the groups to which vehicle M1 belongs. The environment information includes information regarding the area in which vehicle M1 is being driven, the weather of the area in which vehicle M1 is being driven, and the like. The time information includes information regarding the time of day, the day of the week, and the like in which vehicle M1 is being driven.

A plurality of predictions may be made for one vehicle.

Prediction confidence level determiner 15 may determine, instead of or together with the correct prediction accuracy rate, a prediction confidence level based on a reason occurrence probability. Prediction confidence level determiner 15 may determine the prediction confidence level to, for example, a higher value as the reason occurrence probability is higher. For example, in the case where a remote control intervention is performed at time t0 due to a temporary event (such as, for example, there is a vehicle parked on the street) that has occurred at one point, and another vehicle passes through the one point at time t1 after time t0 (where time t1>time t0), it is unnecessary to perform a remote control intervention on the vehicle that passes through the one point at time t1 if the temporary event that occurred at time t0 is eliminated (such as, for example, the vehicle parked on the street is no longer present), from which it can be considered that the remote control intervention occurrence probability decreases over time from time t0. As described above, the remote control intervention occurrence probability that decreases over time may be estimated based on a statistical method of the actual performance information, and used as the reason occurrence probability. The reason occurrence probability may take a smaller value as the length of time from time t0 increases.

Prediction confidence level determiner 15 may group the plurality of vehicles M1 and the like into groups based on at least one of the type of vehicle M1, the environment information regarding the travel environment of vehicle M1, or the time information regarding the travel time of vehicle M1, and calculate the reason occurrence probability for calculating the prediction confidence level of vehicle M1 based on the actual performance information of one or more vehicles included in one of the groups to which vehicle M1 belongs.

Next, screen switch decider 17 determines whether, out of the prediction confidence levels of vehicles M1 and the like, there is one or more prediction confidence levels greater than the threshold value (S15). The threshold value is set and stored in storage 16 in advance.

Next, if it is determined that there is one or more prediction confidence levels greater than the threshold value (Yes in S15), screen switch decider 17 determines to switch the display regarding the vehicle from the overall management screen to the individual management screen (S16). It can also be said that screen switch decider 17 determines the display format for displaying the information regarding the vehicle to the individual management screen. Also, if it is determined that there are two or more prediction confidence levels greater than the threshold value, screen switch decider 17 may identify one vehicle whose remote control intervention timing is closest, or in other words, for which it has been detected that a remote control intervention is required to be performed first, and switch the display regarding the identified vehicle from the overall management screen to the individual management screen.

Also, if the vehicle to be displayed on the individual management screen on first display device 21 is already displayed, screen switch decider 17 determines whether the newly identified vehicle matches the vehicle to be displayed on the individual management screen. If it is determined that the newly identified vehicle does not match the vehicle to be displayed on the individual management screen, screen switch decider 17 switches to the individual management screen on the newly identified vehicle. The vehicle to be displayed on the individual management screen may be, for example, the vehicle that is already displayed on the individual management screen on first display device 21.

Here, the individual management screen will be described with reference to FIG. 6. FIG. 6 is a diagram showing one example of state information displayed on a display device according to the present embodiment. FIG. 6 shows one example of an individual management screen displayed on first display device 21. Also, in FIG. 6, for the sake of convenience, the background portion of the individual management screen is indicated by dots. In FIG. 6, an example will be described in which operator O1 is in charge of remotely controlling vehicle M1.

As shown in FIG. 6, for vehicle M1 whose prediction confidence level determined to be greater than the threshold value, images captured by in-vehicle cameras included in vehicle M1 are displayed on first display device 21 for operator O1 to check. In the example shown in FIG. 6, the individual management screen is divided into the following regions including: front-side display region 21F in which a captured image of an area on the front side of vehicle M1 is displayed; rear-side display region 21B in which a captured image of an area on the rear side of vehicle M1 is displayed; right-side display region 21R in which a captured image of an area on the right side of vehicle M1 is displayed; and left-side display region 21L in which a captured image of an area on the left side of vehicle M1 is displayed. As described above, in the individual management screen, the images captured by vehicle M1 are displayed. Also, information that indicates the prediction confidence level may be displayed on the individual management screen as information that indicates the reason for which vehicle M1 is displayed on the individual management screen. In the example shown in FIG. 6, “confidence level: high” is displayed as the information that indicates the prediction confidence level.

With this configuration, the remote control intervention timing is predicted, and the status of the vehicle whose prediction confidence level is greater than the threshold value, or in other words, the status of the vehicle for which a remote control intervention is highly likely to be actually implemented can be displayed in the display format that has a high information detail level for operator O1 to check.

The individual management screen is not limited to the configuration in which images obtained by capturing the areas in four directions including front, rear, left, and right directions of vehicle M1 are displayed. For example, control may be performed to display images obtained by capturing areas in more directions as the value of the prediction confidence level is greater.

Referring back again to FIG. 5, screen switch decider 17 outputs control information for operator O1 to check the state of vehicle M1 on first display device 21 to operator terminal device D1 (S17). That is, screen switch decider 17 switches the display format for displaying the status of vehicle M1 assigned to operator O1 based on the determined prediction confidence level.

Screen switch decider 17 may frequently change the vehicle displayed on the individual management screen to suppress the occurrence of unnecessary burden on operator O1. For example, screen switch decider 17 may cause information (for example, images) of the vehicle whose display is to be switched to be displayed for a fixed period of time. In other words, it can also be said that screen switch decider 17 prevents the vehicle displayed on the individual management screen from being changed to another vehicle within the fixed period of time. Also, screen switch decider 17 may determine whether to display images based on history information regarding a history of determines made as to whether the prediction confidence level is greater than the threshold value. Screen switch decider 17 may, for example, execute the processing in steps S11 to S15 shown in FIG. 5 a plurality of times, and determine a vehicle for which Yes is determined in step S15 successively a predetermined number of times or the largest number of times out of the plurality of times as the vehicle whose display is to be switched to the individual management screen.

Also, if, for example, it is determined in step S15 that there are two or more vehicles whose prediction confidence level is greater than the threshold value and whose remote control intervention timing will arrive within a predetermined period of time, screen switch decider 17 may determine one of the two or more vehicles whose display is to be switched to the individual management screen by taking into consideration an influence when the remote control intervention is delayed. It can also be said that screen switch decider 17 determines the display format for displaying the status information that indicates the status of one of the two or more vehicles whose prediction confidence level is greater than the threshold value and whose remote control intervention timing will arrive within a predetermined period of time that is identified based on an influence when the start of the remote control is delayed.

For example, screen switch decider 17 may determine to switch the display of one of the two or more vehicles that has the highest impact on safety risk to the individual management screen. As used herein, the term “safety risk” refers to a delay of the remote control intervention, and may also refer to the possibility of the vehicle being involved in an accident, and for example, the vehicle entering an intersection.

Also, for example, screen switch decider 17 may determine to switch the display of one of the two or more vehicles that has the highest impact on recovery cost to the individual management screen. As used herein, the expression “the highest impact on recovery cost” means that, when the remote control intervention is delayed, operator O1 requires the most effort to resolve the problem. By causing operator O1 to check the status of the vehicle on the individual management screen in advance, operator O1 can smoothly perform remote control of the vehicle. For example, in the case where the vehicle is approaching an obstacle, by causing operator O1 to check the status of the vehicle on the individual management screen earlier, it is possible to make a lane change early and avoid the obstacle.

Also, for example, screen switch decider 17 may determine to switch the display of the vehicle that has the highest impact on losses to the individual management screen. The expression “the vehicle that has the highest impact on losses” means the vehicle that requires a long service delay time such as delivery or that has a large opportunity losses due to the delay of the vehicle. It can also be said that the vehicle that has the highest impact on losses is the vehicle with the least time to spare. With this configuration, it is possible to prevent an economic loss from occurring.

Also, if it is determined that there is no prediction confidence level greater than the threshold value (No in S15), screen switch decider 17 ends the processing. In this case, from the viewpoint of suppressing an increase of unnecessary burden on operator O1, screen switch decider 17 may determine to not display using the individual management screen. For example, if No is determined in step S15, there is no need to display an image for checking the vehicle status on first display device 21. Also, screen switch decider 17 may display, in a highlighted manner, vehicle M1 whose prediction confidence level is less than or equal to the threshold value on the overall management screen.

Here, the overall management screen will be described with reference to FIG. 7. FIG. 7 is a diagram showing another example of state information displayed on the display device according to the present embodiment. FIG. 7 shows one example of the overall management screen displayed on second display device 22. In FIG. 7, four vehicles whose vehicles ID are X11 to X14 are assigned to operator O1 who is in charge of the four vehicles. Also, in FIG. 7, the position of a vehicle whose vehicle ID is X11 is indicated by mark B11, the position of a vehicle whose vehicle ID is X12 is indicated by mark B12, the position of a vehicle whose vehicle ID is X13 is indicated by mark B13, and the position of a vehicle whose vehicle ID is X14 is indicated by mark B14. Also, in FIG. 7, the driving route of each vehicle is indicated by a dashed line. Also, in FIG. 7, the threshold value for the prediction confidence level is expressed as “confidence level: X”. For example, “confidence level: high, X11: about 10 minutes later” indicates that the vehicle whose vehicle ID is X11 is the vehicle for which it has been predicted that its remote control intervention timing arrives first (about 10 minutes later) among high prediction confidence levels. Also, “confidence level: medium, X13: about 5 minutes later” indicates that the vehicle whose vehicle ID is X13 is the vehicle for which it has been predicted that its remote control intervention timing arrives first (about 5 minutes later) among medium prediction confidence levels. The same applies to “confidence level: low, X12: 30 seconds later”.

As shown in FIG. 7, second display device 22 displays the status information of all of the four vehicles assigned to operator O1 on one screen. Second display device 22 displays, as the overall management screen, an image for operator O1 to comprehensively check the current position, the driving route, the driving state, and the like of the four vehicles. The driving state includes “driving”, “waiting for a route to be set”, and the like. As used herein, “waiting for a route to be set” refers to a state in which the destination and the like have not been set, and the vehicle is stopped.

With this configuration, it is possible to cause operator O1 to check, in the display format that has an even lower information detail level, the status of the vehicle whose remote control intervention timing is predicted and whose prediction confidence level is less than or equal to the threshold value, or in other words, the status of the vehicle for which a remote control intervention is less likely to be actually implemented. Accordingly, it is possible to reduce the burden and the time of operator O1 to check the status of the vehicle whose prediction confidence level is less than or equal to the threshold value. Accordingly, it is possible to reduce unnecessary burden on operator O1 as compared with the case where the vehicle is displayed on the individual management screen even when the detection is wrong.

Second display device 22 may display at least one of the vehicles on which the remote control intervention is to be performed by highlighting it over the other vehicles. In the example shown in FIG. 7, out of the vehicles on which the remote control intervention is to be performed, the vehicle whose vehicle ID is X12 is the vehicle for which it has been predicted that its remote control intervention timing arrives first among low prediction confidence levels, and thus displayed in a highlighted manner using a thick line. The vehicle whose vehicle ID is X11 and its confidence level is high or the vehicle whose vehicle ID is X13 and its confidence level is medium may be displayed in a highlighted manner over the other vehicles. The vehicle whose vehicle ID is X11 is the vehicle for which it has been predicted that the remote control intervention timing arrives 10 minutes later. The vehicle whose vehicle ID is X12 is the vehicle for which it has been predicted that the remote control intervention timing arrives 30 seconds later. The vehicle whose vehicle ID is X13 is the vehicle for which it has been predicted that the remote control intervention timing arrives 5 minutes later. The vehicle to be displayed in a highlighted manner may be determined by, for example, an input from operator O1.

Also, as the information that indicates the reason for which the vehicle is displayed on the overall management screen, the information that indicates the prediction confidence level may be displayed on the overall management screen.

As described above, when the prediction confidence level is greater than the threshold value, server device 10 determines the display format to a format that has an information detail level higher than that of the display format when the prediction confidence level is less than or equal to the threshold value. For example, when the prediction confidence level is greater than the threshold value, server device 10 causes first display device 21 to display a captured image of the surroundings of vehicle M1 acquired from vehicle M1. When the prediction confidence level is less than or equal to the threshold value, server device 10 causes second display device 22 to display an image obtained by superimposing information regarding vehicle M1 on map information.

When, for example, first display device 21 is not displaying the individual management screen, or when there is time to spare for the next remote control intervention timing, first display device 21 may display vehicle whose vehicle ID is X12 (the vehicle with “confidence level: low”) on the individual management screen. Even the vehicle with “confidence level: low” has the possibility that the remote control intervention takes place. Accordingly, even in such a scene, it is expected that operator O1 can smoothly perform the remote control intervention on the vehicle with “confidence level: low” and to resume the service. Also, for example, if operator O1 checks the vehicle with “confidence level: low” on the individual management screen while knowing that there is time to spare for the next remote control intervention timing of the vehicle with “confidence level: high or medium”, operator O1 can check the individual management screen while understanding the status in which there is time to spare for the next remote control intervention timing of the vehicle with “confidence level: high or medium”. Accordingly, it is possible to prevent the prediction confidence level of the system from being impaired.

On the other hand, additional burden is imposed on operator O1 to monitor the vehicle with “confidence level: low” on the individual management screen. To address this, whether to monitor the vehicle with “confidence level: low” on the individual management screen may be determined by operator O1. If operator O1 can smoothly perform the remote control intervention to smoothly resume the service, an incentive such as additional compensation may be paid to operator O1. For example, when display generator 32 acquires information that indicates to monitor the vehicle with “confidence level: low” on the individual management screen from operator O1 via communicator 31, first display device 21 may display the vehicle with “confidence level: low” on the individual management screen.

The display format that has a high information detail level and the display format that has a low information detail level are not limited to the display formats shown in FIGS. 6 and 7. The display format that has a low information detail level may be a display format in which the information detail level of the displayed image is lower than that of the display format that has a high information detail level, and, for example, the number of displayed images is smaller than that of the display format that has a high information detail level. For example, in the display format that has a high information detail level, four images of areas in the front, the rear, the left, and the right directions may be displayed. In the display format that has a low information detail level, three or less images of areas out of the areas in the front, the rear, the left, and the right directions may be displayed. Also, for example, in the display format that has a high information detail level, the vehicle position, the driving route, and the vehicle status may be displayed on the map. In the display format that has a low information detail level, only the vehicle position may be displayed on the map.

### Variations of Embodiment

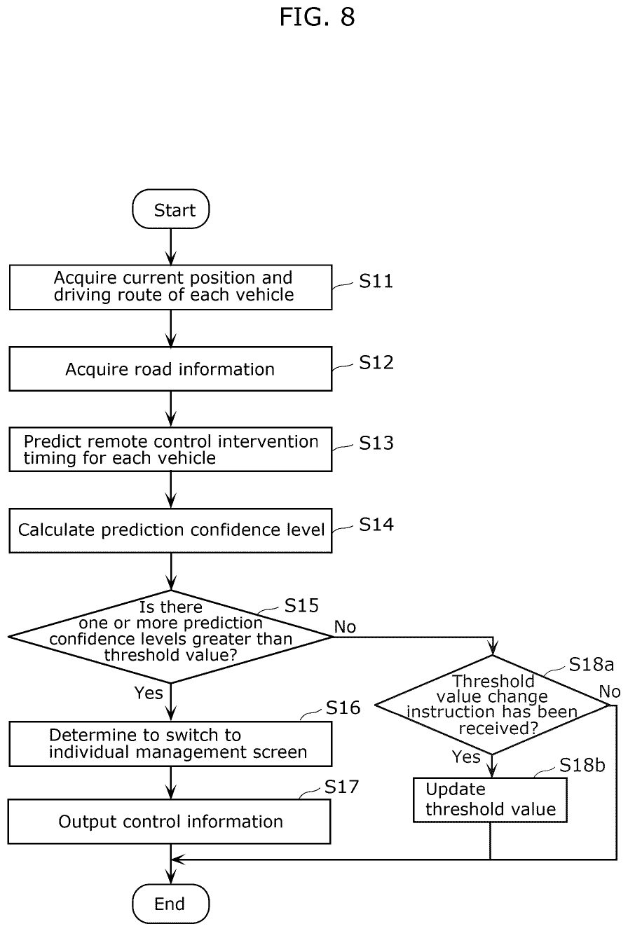

Hereinafter, variations according to the embodiment will be described with reference to FIGS. 8 to 17. Hereinafter, differences from the embodiment will be mainly described, and a description of elements that are the same as or similar to those of the embodiment will be omitted or simplified. Information processing systems according to the following variations may have the same configuration as that of information processing system 1 according to the embodiment, and thus a description thereof will be omitted. Also, in the following description, the same reference numerals as those used in information processing system 1 of the embodiment will be used.

### (Variation 1 of Embodiment)

Hereinafter, an information processing system according to the present variation will be described with reference to FIG. 8.

FIG. 8 is a flowchart illustrating an operation (an information processing method) of information processing system 1 according to the present variation.

As shown in FIG. 8, if it is determined that there is no prediction confidence level greater than the threshold value (No in S15), screen switch decider 17 further determines whether a threshold value change instruction has been received (S18a). The threshold value change instruction is an instruction to change the threshold value used in step S15 to make the determination. if No is determined in step S15, screen switch decider 17 may cause one of first display device 21 or second display device 22 to display information for operator O1 to determine whether to change (for example, lower) the threshold value for the prediction confidence level, and acquire the selection of operator O1 received by the input device as the threshold value change instruction.

If it is determined that a threshold value change instruction has been received (Yes in S18a), screen switch decider 17 updates the threshold value stored in storage 16 (S18b). If it is determined that a threshold value change instruction has not been received (No in S18a), screen switch decider 17 ends the processing.

Screen switch decider 17 may change the threshold value according to the status of operator O1. Screen switch decider 17 may cause, for example, one of first display device 21 or second display device 22 to shows a display on which operator O1 can actively change the threshold value at any time. Then, screen switch decider 17 may change the threshold value according to an input from operator O1.

### (Variation 2 of Embodiment)

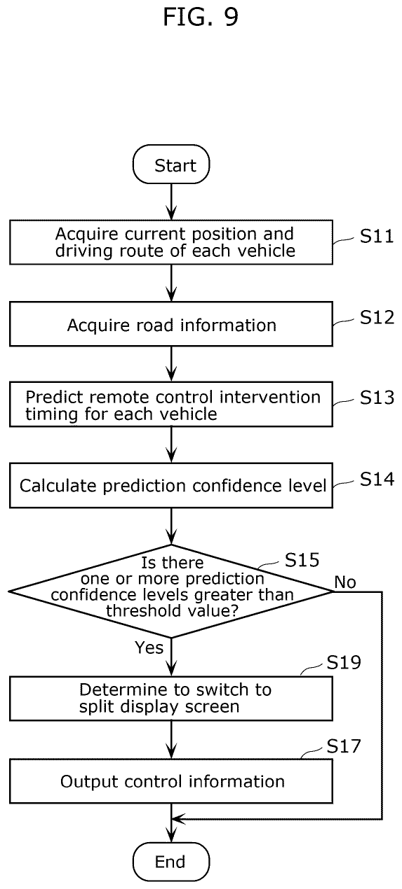

Hereinafter, an information processing system according to the present variation will be described with reference to FIGS. 9 to 12.

FIG. 9 is a flowchart illustrating an operation (an information processing method) of information processing system 1 according to the present variation.

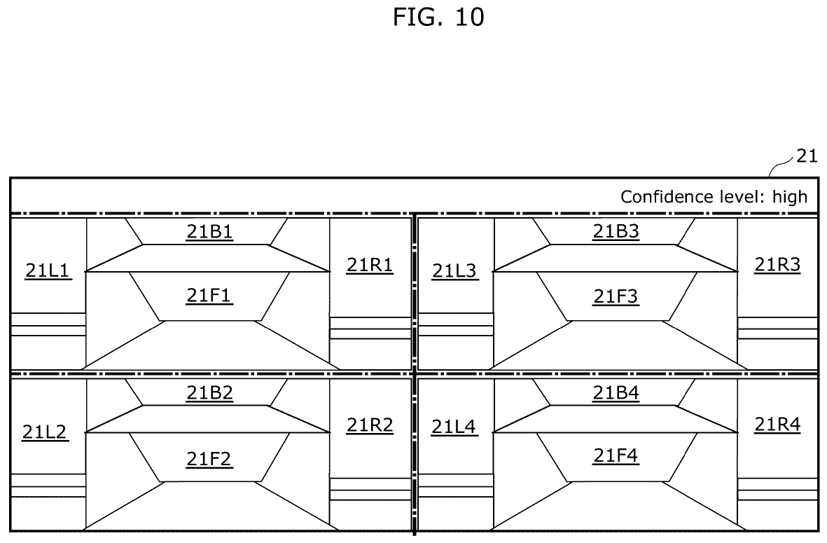

As shown in FIG. 9, if it is determined that there is one or more prediction confidence levels greater than the threshold value (Yes in S15), screen switch decider 17 determines to switch the display of the vehicle from the overall management screen to a split display screen (see FIG. 10, which will be described later) (S19). As used herein, the term “split display screen” refers to a screen for simultaneously displaying a predetermined number of vehicles whose prediction confidence level is greater than the threshold value on the same screen, and the screen is divided into a predetermined number of split display regions. For example, the status of one vehicle is displayed in one split display region. That is, by switching to the split display screen, operators O1 and the like can simultaneously check the status of the predetermined number of vehicles in detail. Also, the predetermined number of vehicles have a prediction confidence level higher than the threshold value, and thus checking the status is unlikely to be a waste of time.

if it is determined that there are two or more prediction confidence levels greater than the threshold value, screen switch decider 17 may select a candidate vehicle whose remote control intervention timing is within a predetermined period of time (for example, whose remote control intervention timing arrives first). Then, if the number of candidate vehicles selected is less than or equal to the number of split display regions, screen switch decider 17 may cause operator terminal device D1 to generate the split display screen for displaying the vehicles. Screen switch decider 17 may determine an arrangement of the plurality of vehicles on the screen in the order of, for example, the remote control intervention timing.

Also, if first display device 21 is displaying the status of one or more vehicles on the individual management screen or the split display screen at the present time, and it is determined that there is a new vehicle whose prediction confidence level is greater than the threshold value, screen switch decider 17 may display all of the vehicles on the split display screen. In this case, screen switch decider 17 may display a region for displaying the status of the new vehicle added to the split display screen in a highlighted manner over the other regions for displaying the status of the other vehicles.

Also, if it is determined that there is one prediction confidence level greater than the threshold value, screen switch decider 17 may display only the vehicle whose prediction confidence level is greater than the threshold value on the split display screen (or in other words, the screen whose number of splits is 1). The split display screen whose number of splits is 1 may be the same screen as the individual management screen.

If it is determined that there is no prediction confidence level greater than the threshold value (No in S15), or in other words, if vehicles M1 and the like have a prediction confidence level less than or equal to the threshold value, screen switch decider 17 may present information for changing the threshold value to operators O1 and the like.

Here, the split display screen will be described with reference to FIG. 10. FIG. 10 is a diagram showing one example of state information displayed on a display device according to the present embodiment. FIG. 10 shows one example of a split display screen displayed on first display device 21. In FIG. 10, an example will be described in which, out of the plurality of vehicles M1 and the like assigned to operator O1, the status of four vehicles are simultaneously displayed on the same screen.

As shown in FIG. 10, for four vehicles whose prediction confidence level is determined to be greater than the threshold value, images captured by in-vehicle cameras included in the four vehicles are displayed on first display device 21 to operator O1. In the example shown in FIG. 10, the split display screen is divided into four regions separated by a dash-dotted line. In this case, four corresponds to one example of a predetermined number of split display regions (the number of splits).

A first split display region (an upper left region) is divided into four regions including: front-side display region 21F1 in which a captured image of an area on the front side of a first vehicle is displayed; rear-side display region 21B1 in which a captured image of an area on the rear side of the first vehicle is displayed; right-side display region 21R1 in which a captured image of an area on the right side of the first vehicle is displayed; and left-side display region 21L1 in which a captured image of an area on the left side of the first vehicle is displayed.

Likewise, each of a second split display region (a lower left region), a third split display region (an upper right region), and a fourth split display region (a lower right region) is divided into four regions including: front-side display regions 21F2 to 21F4; rear-side display regions 21B2 to 21B4; right-side display regions 21R2 to 21R4; and left-side display regions 21L2 to 21L4 in each of which a captured image of an area in each direction of a corresponding one of the second to fourth vehicles is displayed.

As described above, on the split display screen, images captured by a plurality of vehicles are arranged side by side and simultaneously displayed.

The number of splits on the split display screen (or in other words, the number of vehicles that can be displayed on the split display screen) may be determined based on content of the remote control that the operator is to perform. The number of splits may be changed according to, for example, the difficulty of remote monitor or remote control, or the like. The number of splits may be determined based on a correspondence table in which the content of remote control is associated with the number of splits. For example, the number of splits may be reduced more as the difficulty of remote monitor or remote control is higher, and the number of splits may be increased more as the difficulty of remote monitor or remote control is lower. The number of splits corresponds to the predetermined number of split display regions.

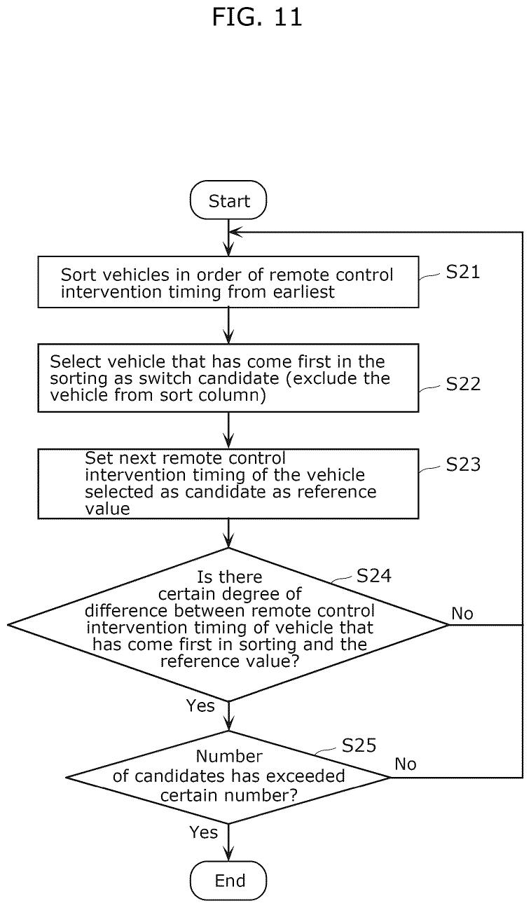

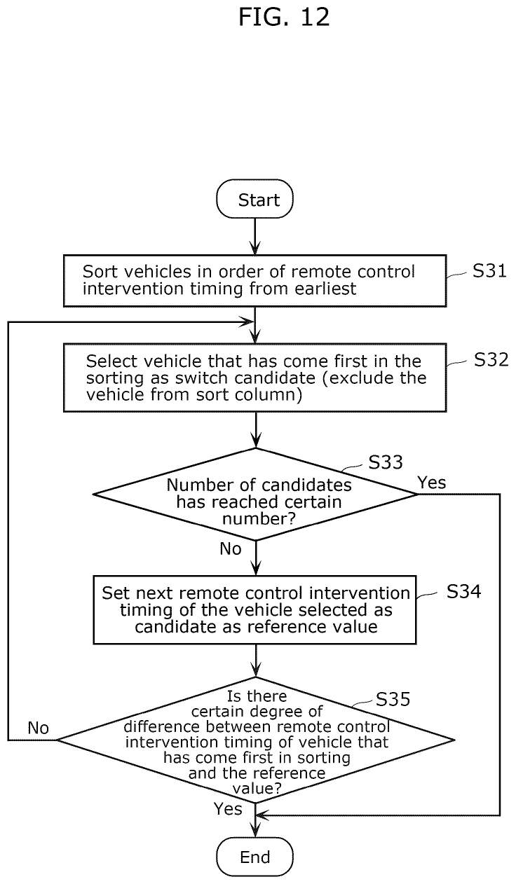

Next, an operation of selecting vehicles to be displayed on the split display screen will be described with reference to FIGS. 11 and 12. FIG. 11 is a flowchart illustrating one example of an operation (an information processing method) of selecting vehicles to be displayed on the split display screen according to the present variation. In FIG. 11, an example will be described in which a plurality of vehicles that have close remote control intervention timings are selected as the vehicles to be displayed on the split display screen. The operation shown in FIG. 11 may be executed, for example, after Yes has been determined in step S15.

As shown in FIG. 11, screen switch decider 17 sorts the vehicles in order of the remote control intervention timing from the earliest (S21), and selects, from among the vehicles, a vehicle that has come first in the sorting as a switch candidate for which switching is to be performed (S22). The selected vehicle may be removed from the sorting. That is, the sorting may be updated by removing the vehicle selected as the switch candidate for which switching is to be performed.

Next, screen switch decider 17 sets, as a reference value, a time of the next remote control intervention timing for the vehicle selected as the candidate (S23), and then determines whether there is a certain degree of difference between the remote control intervention timing for a vehicle that has come first in sorting and the reference value (S24). The expression “a vehicle that has come first” used in step S24 refers to a vehicle that has come first in sorting that is performed after the vehicle selected in step S22 has been excluded.

Next, if it is determined that there is a certain degree of difference between the remote control intervention timing for the vehicle that has come first in the sorting and the reference value (Yes in S24), screen switch decider 17 determines whether the number of candidate vehicles has exceeded a certain number (S25). If it is determined that the number of candidate vehicles has exceeded the certain number (Yes in S25), screen switch decider 17 ends the processing. With this configuration, a certain number of vehicles that have close remote control intervention timings are selected as the vehicles to be displayed on the split display screen.

If it is determined that there is no certain degree of difference between the remote control intervention timing for the vehicle that has come first in the sorting and the reference value (No in S24), or if it is determined that the number of candidate vehicles has not exceeded the certain number (No in S25), screen switch decider 17 causes the processing to return to step S21 and continue.

With this configuration, the vehicles that have close remote control intervention timings can be selected as the vehicles to be displayed on the split display screen. For example, it is possible to prevent a situation where vehicles whose prediction confidence level is high, but whose remote control intervention timing is different are displayed on the split display screen, and thus there is no need for operators O1 and the like to check vehicles that do not need to be checked immediately. Accordingly, it is possible to suppress the occurrence of unnecessary burden on operators O1 and the like.

The processing in step S25 does not necessarily need to be performed. In this case, all vehicles that have close remote control intervention timings can be selected as candidate vehicles to be displayed on the split display screen.

FIG. 12 is a flowchart illustrating another example of an operation (information processing method) of selecting vehicles to be displayed on the split display screen according to the present variation. In FIG. 12, an example will be described in which vehicles are selected by limiting the number of candidate vehicles such as the number of split display regions. The operation shown in FIG. 12 may be performed, for example, after Yes is determined in step S15. Steps S31 and S32 are the same as steps S21 and S22 shown in FIG. 11, and thus a description thereof is omitted here.

As shown in FIG. 12, screen switch decider 17 selects one of the vehicles that has come first in the sorting as a switch candidate for which switching is to be performed (S32), and then determines whether the number of candidates has reached a certain number (S33). If it is determined that the number of candidates has reached the certain number (Yes in S33), screen switch decider 17 ends the processing. If it is determined that the number of candidates has not reached the certain number (No in S33), screen switch decider 17 sets, as a reference value, a time of the next remote control intervention timing of the vehicle selected as the candidate (S34), and then determines whether there is a certain degree of difference between the remote control intervention timing for the vehicle that has come first in the sorting and the reference value (S35). If it is determined that there is a certain degree of difference (Yes in S35), screen switch decider 17 ends the processing. If it is determined that there is no certain degree of difference (No in S35), screen switch decider 17 causes the processing to return to step S32 and continue.

With this configuration, a limited number of vehicles to be displayed on the split display screen can be selected. For example, only the status of a number of vehicles limited (determined) according to the skill, the fatigue level, and the like of operators O1 and the like is displayed on the split display screen. Accordingly, a number of vehicles greater than or equal to the number of operators O1 and the like are displayed, and it is therefore possible to suppress the occurrence of excessive burden on operators O1 and the like. The skill, the fatigue level, and the like of operators O1 and the like may be included in the operator information.

When the remote control intervention timing comes, first display device 21 may switch the screen from the split display screen to a screen (for example, the individual management screen) for checking only the status of the vehicle on which the remote control intervention is to be performed.

### (Variation 3 of Embodiment)

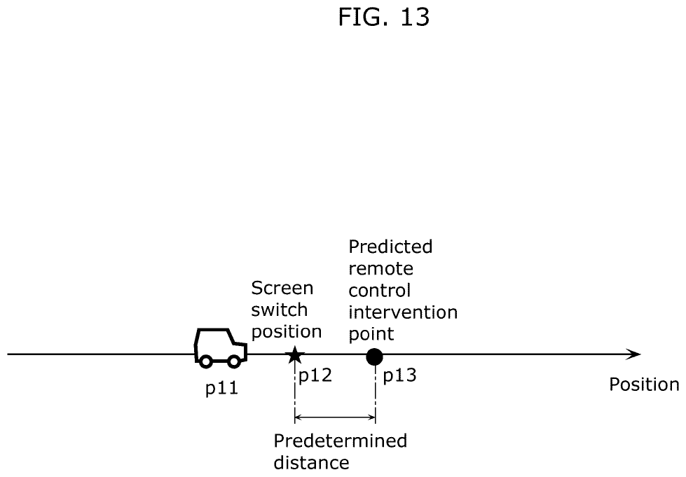

Hereinafter, an information processing system according to the present variation will be described with reference to FIG. 13.

FIG. 13 is a diagram illustrating a display screen switch timing according to the present variation. FIG. 13 is a diagram showing a display screen switch timing at which the display screen assigned to operator O1 is actually switched when, for example, it is determined in step S16 shown in FIG. 8 that screen switch decider 17 determines to switch to the individual management screen. Position p11 indicates a current vehicle position, position p13 indicates a position of a predicted remote control intervention point, and position p12 indicates a screen switch position.

As shown in FIG. 13, terminal controller 33 according to the present variation performs control to switch the screen on first display device 21 that is checked by operator O1 (for example, to switch to the individual management screen) when the vehicle arrives at a point (position p12) that is in advance of a point (position p13) that is a predicted remote control intervention point by a predetermined distance. The predetermined distance is a distance that corresponds to a preparation starting point for preparing the remote control intervention performed by operator O1, but is not limited thereto. The predetermined distance is set in advance. Also, as the predetermined distance, one common value that is shared by the plurality of operators O1 may be set, or different values may be set. The predetermined distance may be set based on, for example, the duration required for operator O1 to recognize the vehicle status or the like.

For example, if the screen switch timing at which first display device 21 is switched is too early, the length of time during which operator O1 has to closely monitor the screen increases, which increases the burden on operator O1 to monitor the screen. If the screen switch timing is too late, operator O1 cannot sufficiently recognize the vehicle status in advance and thus may not be able to smoothly perform the remote control.

To address this, control is performed to, by switching the screen display at the timing shown in FIG. 13, switch the screen within a period required for preparing the remote control intervention in advance. With this configuration, the length of time during which operator O1 has to closely monitor the screen on first display device 21 can be reduced. Accordingly, it is possible to reduce the burden on operator O1 to monitor the screen, and smoothly perform the remote control.

Terminal controller 33 may perform control to switch the screen on first display device 21 that is checked by operator O1 when the time arrives at a point in time prior to the predicted time at which it has been predicted that the vehicle arrives at the predicted remote control intervention point by a predetermined length of time.

### (Variation 4 of Embodiment)

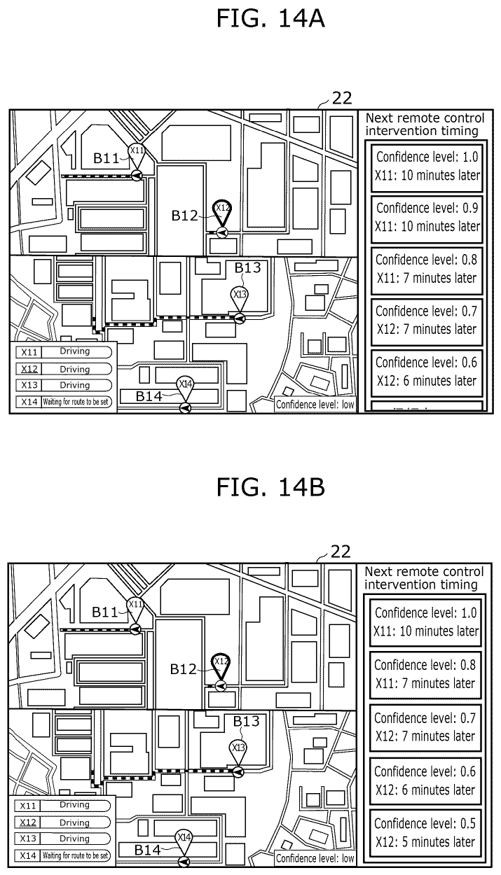

Hereinafter, an information processing system according to the present variation will be described with reference to FIG. 14A and FIG. 14B.

In FIG. 7 of the embodiment, an example was described in which the threshold value for the prediction confidence level was expressed as “high”, “medium”, or “low”. In the present variation, another example of the threshold value for the prediction confidence level will be described.

FIG. 14A is a diagram showing one example of state information displayed on a display device according to the present variation (here, second display device 22). FIG. 14A shows one example of an overall management screen displayed on second display device 22. In FIGS. 14A and 14B, four vehicles whose vehicles ID are X11 to X14 are assigned to operator O1 who is in charge of the four vehicles, as in the case of FIG. 7.

In FIGS. 14A and 14B, the threshold value for the prediction confidence level is expressed as “confidence level: numerical value”. For example, “confidence level: 1.0, vehicle X11: 10 minutes later” indicates that the vehicle whose vehicle ID is X11 is the vehicle for which it has been predicted that its remote control intervention timing arrives first (10 minutes later) among prediction confidence levels of 1.0 or more. Also, “confidence level: 0.9, vehicle X11: 10 minutes later” indicates that the vehicle whose vehicle ID is X11 is the vehicle for which it has been predicted that its remote control intervention timing arrives first (10 minutes later) among prediction confidence levels of 0.9 or more. The same applies to “confidence level: 0.8, vehicle X11: 7 minutes later” and the like.

As shown in FIG. 14A, the threshold value for the prediction confidence level may be expressed using a numerical value. In FIG. 14A, an example is shown in which the threshold value is a value in a ten-level scale (for example, with an increment of 0.1), with the maximum value being set to 1.0 and the minimum value being set to 0.0. However, the maximum value of the threshold value, the minimum value of the threshold value, the number of levels in the scale, and the increment are not limited thereto. Also, in FIG. 14A, an example is shown in which many threshold values have been set, and thus some of the threshold values (with a confidence level of 0.5 or less) cannot be displayed.

FIG. 14B is a diagram showing one example of state information in which a display of a remote control intervention timing has been removed from the state information shown in FIG. 14A, with one or a pre-set number of remote control intervention timings being left.

In FIG. 14A, an example is shown in which the same remote control intervention timing is obtained even when the threshold value is changed such as “confidence level: 1.0, vehicle X11: 10 minutes later” and “confidence level: 0.9, vehicle X11: 10 minutes later”. In this case, as shown in FIG. 14B, a display of a remote control intervention timing may be removed from the state information shown in FIG. 14A, with one or a pre-set number of remote control intervention timings being left. FIG. 14B shows an example in which “confidence level: 0.9, vehicle X11: 10 minutes later” (a display of a remote control intervention timing with a lower prediction confidence level) has been removed.

In the case where many threshold values have been set, the display may be controlled such that another threshold value can be selected by scrolling. The control of the display is performed by terminal controller 33.

### (Variation 5 of Embodiment)

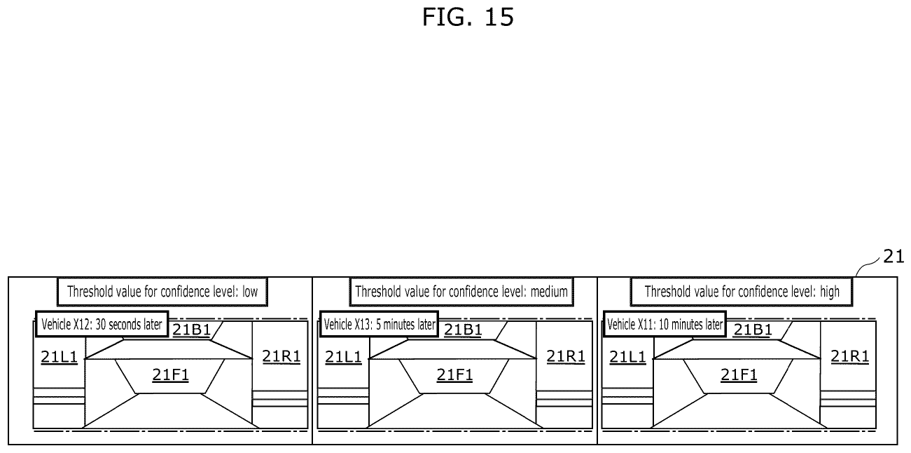

Hereinafter, an information processing system according to the present variation will be described with reference to FIGS. 15 to 17.

In the present variation, another example of a screen displayed on first display device 21 will be described.

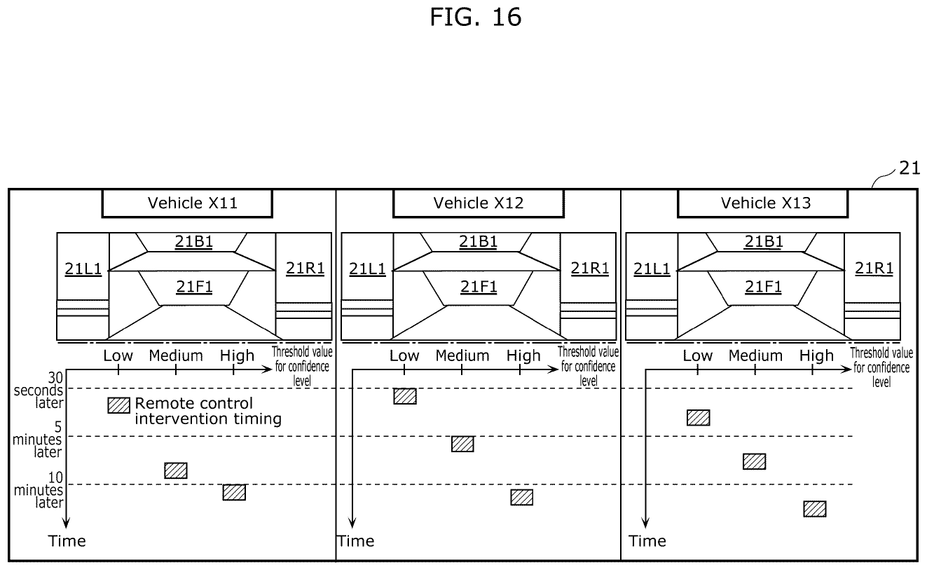

FIGS. 15 to 17 are diagrams showing examples of state information displayed on a display device (in this example, first display device 21) according to the present variation. In FIGS. 15 and 16, a display example is shown in which the number of vehicles operator O1 has to check is three. The display on first display device 21 is performed by terminal controller 33.

When the threshold value for the prediction confidence level is changed, the vehicle for which it has been predicted that the remote control intervention is performed next may vary. Accordingly, as shown in FIG. 15, first display device 21 may display a split screen that includes individual management screens of the vehicles for which it has been predicted that the remote control intervention is required to be performed next according to the threshold value. The example shown in FIG. 15 shows a split screen (including three split screens) displayed on first display device 21 when, out of the vehicles whose threshold value for the prediction confidence level is set to “low”, vehicle X12 has a first remote control intervention timing of 30 seconds later, out of the vehicles whose threshold value for the prediction confidence level is set to “medium”, vehicle X13 has a first remote control intervention timing of 5 minute later, and out of the vehicles whose threshold value for the prediction confidence level is set to “high”, vehicle X11 has a first remote control intervention timing of 10 minutes later. The number of splits is not limited to three as long as the number of splits is greater than or equal to two.

Also, if the number of vehicles that each of operators O1 and the like needs to check is not enormous (for example, is less than or equal to a threshold value set for each operator O1), as shown in FIG. 16, first display device 21 may constantly display a split screen that includes individual management screen of all vehicles X11 to X13.

Also, first display device 21 may further display the remote control intervention timing for each threshold value for the prediction confidence level (using a rectangular frame hatched with oblique lines shown in FIG. 16) on a Gantt chart. In the Gantt chart, the vertical axis indicates time (the remote control intervention timing), and the horizontal axis indicates the threshold value for the prediction confidence level. The vertical axis may be, instead of being labeled with equal intervals of one second, displayed such that the time width exponentially decreases over time. With this configuration, operator O1 can observe the state (the status of remote control intervention) in the more distant future.

Also, as a result of the Gantt chart being displayed, operator O1 can intuitively recognize the next remote control intervention timing for each vehicle according to the threshold value.

First display device 21 may move the rectangular frame in a direction in which the length of time decreases (upward in the example shown in FIG. 16) over time. For example, first display device 21 may move the rectangular frame upward according to a predetermined time interval (a predetermined rhythm).

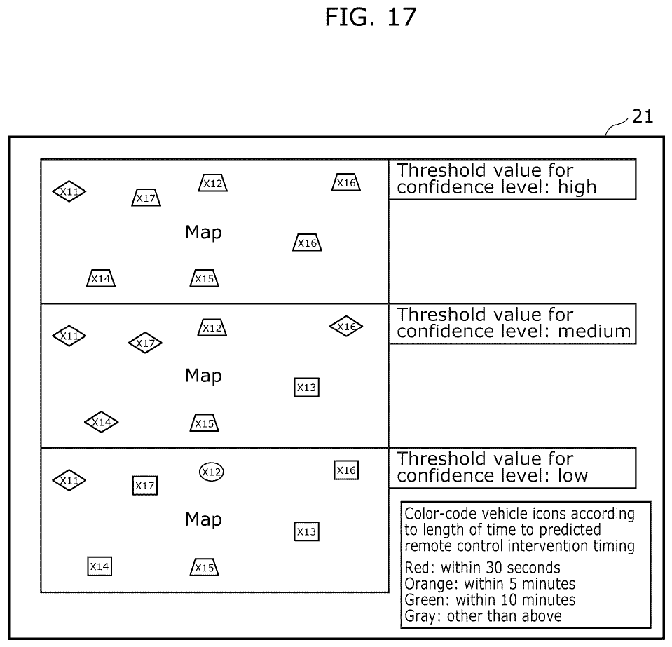

Also, first display device 21 may make a number of copies of the same map corresponding to the number of variations of the threshold value (three including “high”, “medium”, and “low” in the example shown in FIG. 17), and then display a screen in which vehicle icons are color-coded according to the length of time to the predicted remote control intervention timing, as the overall management screen. The map indicates the positions of the vehicles. In FIG. 17, each color is indicated by a different frame shape. In FIG. 17, a red icon that represents a vehicle for which the length of time to the predicted remote control intervention timing is within 30 seconds is indicated by an elliptic frame. An orange icon that represents a vehicle for which the length of time to the predicted remote control intervention timing is longer than 30 seconds and within 5 minutes is indicated by a rectangular frame. A green icon that represents a vehicle for which the length of time to the predicted remote control intervention timing is longer than 5 minutes and within 10 minutes is indicated by a rhombic frame. A gray icon that represents a vehicle for which the length of time to the predicted remote control intervention timing is other than the above (for example, longer than 10 minutes) is indicated by a trapezoidal frame. The color-coding based on the remote control intervention timing and the time range of the remote control intervention timing indicated by each color are merely examples, and thus are not limited to those shown in FIG. 17.

As shown in FIG. 17, first display device 21 may display the same map for each of the prediction confidence levels “high”, “medium”, and “low”, and display different vehicle icons according to the length of time to the remote control intervention timing that is based on the prediction confidence level.

As a result of the screen shown in FIG. 17 being displayed, operator O1 can first look at the map at “confidence level: high” to confirm that there is one vehicle (vehicle X11) for which the remote control intervention is to be implemented within 10 minutes, and then determine that there is still time to spare and thus check the remote control intervention timing at a lower prediction confidence level. As described above, as a result of the screen shown in FIG. 17 being displayed, it is possible to effectively cause operator O1 to perform the remote control intervention.

### (Variation 6 of Embodiment)

In the present variation, an example will be described in which an expected value is calculated using the prediction confidence level described above and the degree of influence on at least one of vehicle safety or service efficiency, and the calculated expected value is used as the prediction confidence level that is compared with the threshold value. The degree of influence indicates the degree of influence on safety and efficiency if the prediction confidence level is wrong. For example, a value (priority level) of 1 or more and N or less (where N is a natural number) is assigned according to the vehicle status (for example, the state of the surroundings of the vehicle). For example, the degree of influence may be set according to the vehicle status for each vehicle in advance.

A safety priority level may be determined based on, for example, the actual performance in a first perspective as to whether an accident or an incident actually occurs by a delay of operation under the situation. Also, an efficiency priority level may be determined based on, for example, the actual performance in a second perspective as to whether a delay of operation under the situation actually contributes to an increase in losses, for example, an increase in the length of time from when a customer places an order to when the customer receives the ordered item such as food delivery. Also, in the case where prioritization is not possible on the same level due to the perspective being different, a plurality of priority levels may be designed by giving a priority level to each perspective and also giving a priority level between perspectives. The priority level between perspectives is the degree of priority that indicates which of the plurality of perspectives including the first perspective and the second perspective is to be prioritized.

Prediction confidence level determiner 15 sets the prediction confidence level to a probability of 0 or more and 1 or less, assigns the safety priority level and the efficiency priority level according to the vehicle status as the degree of influence, and calculates the expected value based on the probability and the degree of influence. The expected value may be determined by calculating (for example, multiplying), for example, the probability with the degree of influence. Also, prediction confidence level determiner 15 may determine the calculated expected value as the prediction confidence level that is compared with the threshold value.

Also, prediction confidence level determiner 15 may also predict which of a plurality of situations to which the safety and the efficiency correspond. In this case, prediction confidence level determiner 15 may also calculate the degree of influence in the same manner using the expected value.

### Other Embodiments

Up to here, the embodiment and the variations of the present disclosure (hereinafter also referred to as “the embodiment and the like”) have been described. The present disclosure is not limited to the embodiment and the like described above.

For example, in the embodiment and the like described above, prediction confidence level determiner 15 may determine the prediction confidence level as to whether the remote control intervention is required, based on the reason for the prediction that remote control is required to be performed on vehicles M1 and the like.

Also, in the embodiment and the like described above, a vehicle is used as an example of the mobile body. However, the mobile body may be any object such as, for example, a flying object (for example, a drone) as long as it is possible to switch between autonomous driving and remote control driving.

Also, the threshold value for the prediction confidence level used in the embodiment and the like described above may be determined as appropriate. For example, in the case where, out of four predictions that the remote control intervention is necessary, the remote control intervention is necessary only once, the threshold value in this case may be set to 25%. Also, the threshold value may be automatically updated when the actual performance information (for example, the correct prediction accuracy rate) is updated. Also, as the threshold value, for example, one common value that is common to reasons for which it has been predicted that the remote control is necessary may be set, or different values may be set for each of the reasons.

Also, in the embodiments described above, in the case where there are a plurality of mobile bodies whose prediction confidence level is greater than the threshold value, one of the prediction confidence levels that has the highest priority is identified based on the order of priority set in advance, and an image of the vehicle that corresponds to the identified prediction confidence level may be displayed on the individual management screen. The order of priority may be set, for example, for each reason for which it has been predicted that the remote control is necessary.

Also, in each of the individual management screen, the overall management screen, and the split display screen in the embodiment and the like described above, the explanation of the predicted remote control intervention and the items to check may be notified to the operator using a text or a sound/voice.

Also, in the embodiment and the like described above, the structural elements may be configured using dedicated hardware, or may be implemented by executing a software program suitable for the structural elements. The structural elements may be implemented by a program executor such as a CPU or a processor reading and executing a software program recorded in a recording medium such as a hard disk or a semiconductor memory.

Also, the order of steps performed in each of the flowcharts is merely an example to specifically describe the present disclosure. Accordingly, the steps of each of the flowcharts may be performed in an order other than those described above. Also, some of the steps may be performed simultaneously (in parallel) with the other steps, or some of the steps may not necessarily be performed.

Also, the functional blocks shown in the block diagrams are merely examples. Accordingly, it is possible to implement a plurality of functional blocks as a single functional block, or divide a single functional block into a plurality of blocks. Alternatively, some functions may be transferred to other functional blocks. Also, the functions of a plurality of functional blocks that have similar functions may be processed by a single piece of hardware or software in parallel or by time division.

Also, the service device according to the embodiment and the like described above may be implemented by a single device or a plurality of devices. In the case where the server device is implemented using a plurality of devices, the structural elements of the server device may be assigned to the plurality of devices in any way. In the case where the server device is implemented using a plurality of devices, there is no particular limitation on the method of communication performed between the plurality of devices, and the method of communication performed between the plurality of devices may be wireless communication or wired communication. Also, a combination of wireless communication and wired communication may be used between the devices. Also, at least one function of the server device may be implemented using an operator terminal device or an in-vehicle device.

The structural elements described in the embodiment and the like described above may be implemented as software, typically as an integrated circuit that is large scale integration (LSI). These may be individual single chips, or a part or all of these may be configured in a single chip. LSI is used here, but the LSI may be called IC, system LSI, super LSI, or ultra LSI according to the degree of integration. Also, implementation of an integrated circuit is not limited to LSI, and may be realized by a dedicated circuit (a general-purpose circuit that executes a dedicated program) or a general-purpose processor. It is also possible to use a field programmable gate array (FPGA) that can be programmed after LSI production or a reconfigurable processor that enables reconfiguration of the connection and setting of circuit cells in the LSI. Furthermore, if an integrated circuit technique that can replace LSI emerges due to advances in semiconductor technology or other derivative technologies, of course, that technology may be used to integrate the structural elements.

The system LSI is a super multifunctional LSI manufactured by integrating a plurality of processors on a single chip, and is specifically a computer system that includes a microprocessor, a read only memory (ROM), a random access memory (RAM), and the like. A computer program is stored in the ROM. The functions of the system LSI are implemented as a result of the microprocessor operating in accordance with the computer program.

Also, one aspect of the present disclosure may be a computer program that causes a computer to execute characteristic steps included in the information processing methods shown in FIGS. 5, 8, 9, 11, and 12.

Also, for example, the program may be a program executed by a computer. Also, one aspect of the present disclosure may be a computer-readable non-transitory recording medium in which the program is recorded. For example, the program may be recorded in the recording medium, and then widely spread or distributed. For example, the widely spread program may be installed on a device that includes a processor. By causing the processor to execute the program, it is possible to cause the device to perform the processing operations described above.

### INDUSTRIAL APPLICABILITY

The present disclosure is applicable to an information processing method for an operator to remotely control a mobile body.

1. An information processing method executed by a computer, the information processing method comprising:
acquiring position information that indicates a current position of a mobile body and route information that indicates a travel route of the mobile body;
acquiring road information;
predicting at least one of a remote control intervention point or a remote control intervention timing at which an operator who is capable of remotely controlling the mobile body starts remote control of the mobile body based on the position information, the route information, and the road information;
determining a prediction confidence level for the at least one of the remote control intervention point or the remote control intervention timing predicted; and
determining, based on the prediction confidence level determined, a display format for displaying status information that indicates a status of the mobile body to be displayed to the operator before the operator starts the remote control.

2. The information processing method according to claim 1,
wherein the prediction confidence level is determined based on a prediction accuracy of the at least one of the remote control intervention point or the remote control intervention timing predicted.

3. The information processing method according to claim 2,
wherein the prediction confidence level is determined based on actual performance information that includes: (i) at least one of a remote control intervention point or a remote control intervention timing predicted in a past for a reason that is same as a reason for which the remote control on the mobile body has been predicted to be necessary; (ii) and an actual performance of the remote control performed at the at least one of the remote control intervention point or the remote control intervention timing predicted in the past.

4. The information processing method according to claim 3,
wherein the actual performance information includes information regarding a correct prediction accuracy rate of the at least one of the remote control intervention point or the remote control intervention timing predicted in the past, and
the prediction confidence level is determined based on the correct prediction accuracy rate.

5. The information processing method according to claim 4,
wherein a plurality of mobile bodies including the mobile body are present, and
the information processing method further comprises:
grouping the plurality of mobile bodies into one or more groups based on at least one of a mobile body type, environment information regarding a mobile body travel environment, or time information regarding a mobile body travel time; and
calculating, for each of the plurality of mobile bodies, the correct prediction accuracy rate for calculating the prediction confidence level of the mobile body, based on actual performance information of one or more mobile bodies included in the one or more groups to which the mobile body belongs.

6. The information processing method according to claim 1,
wherein the prediction confidence level is determined based on a reason occurrence probability of a reason for which the remote control on the mobile body has been predicted to be necessary.

7. The information processing method according to claim 6,
wherein a plurality of mobile bodies including the mobile body are present, and
the information processing method further comprises:
grouping the plurality of mobile bodies into one or more groups based on at least one of a mobile body type, environment information regarding a mobile body travel environment, or time information regarding a mobile body travel time; and
calculating, for each of the plurality of mobile bodies, the correct prediction accuracy rate for calculating the prediction confidence level of the mobile body, based on actual performance information of one or more mobile bodies included in the one or more groups to which the mobile body belongs, and
the actual performance information includes information regarding the reason occurrence probability.

8. The information processing method according to claim 1, further comprising:
determining whether the prediction confidence level is greater than a threshold value; and
when the prediction confidence level is determined to be greater than the threshold value, determining the display format to a format that has an information detail level higher than an information detail level when the prediction confidence level is determined to be less than or equal to the threshold value.

9. The information processing method according to claim 8, further comprising:
when the prediction confidence level is determined to be greater than the threshold value, displaying an image of surroundings of the mobile body captured by and acquired from the mobile body; and
when the prediction confidence level is determined to be less than or equal to the threshold value, displaying information regarding the mobile body on map information.

10. The information processing method according to claim 9, further comprising:
displaying the image for a fixed period of time when the prediction confidence level is determined to be greater than the threshold value.

11. The information processing method according to claim 9, further comprising:
determining whether to display the image based on history information regarding a history of determinations as to whether the prediction confidence level is greater than the threshold value.

12. The information processing method according to claim 8, further comprising:
determining the prediction confidence level for each of the plurality of mobile bodies; and
when the plurality of mobile bodies include two or more mobile bodies whose prediction confidence level is greater than the threshold value, determining a display format for displaying status information that indicates a status of one of the two or more mobile bodies that is identified based on an influence when start of the remote control is delayed.

13. The information processing method according to claim 1, further comprising:
determining the prediction confidence level for each of the plurality of mobile bodies; and
displaying, in a predetermined number of split display regions into which a display screen on a display device is divided, based on the prediction confidence level of each of the plurality of mobile bodies, status information of a predetermined number of mobile bodies corresponding to the predetermined number of split display regions.

14. The information processing method according to claim 13, further comprising:
displaying, in a highlighted manner, one of the predetermined number of split display regions in which status information of a new mobile body is displayed.

15. The information processing method according to claim 13,
wherein the predetermined number of split display regions is determined based on content of the remote control that the operator is to perform.

16. The information processing method according to claim 1, further comprising:
determining the prediction confidence level for each of the plurality of mobile bodies; and
when the prediction confidence level of the mobile body is determined to be less than or equal to a threshold value, presenting, to the operator, information for changing the threshold value.

17. The information processing method according to claim 1,
wherein the road information includes section information that indicates at least one of a section where autonomous driving is prohibited or a section where autonomous driving is not permitted to be continued, and
the at least one of the remote control intervention point or the remote control intervention timing is predicted based on the section information.

18. A terminal device comprising:
an acquirer that acquires information that indicates a display format for displaying the status information of the mobile body determined using the information processing method according to claim 1; and
a controller that causes a display device to display the status information in the display format acquired, the display device being assigned to an operator who is in charge of remotely controlling the mobile body.

19. A non-transitory computer-readable recording medium having recorded thereon a program for causing a computer to execute the information processing method according to claim 1.
